(19) United States
(12) Patent Application Publication
(10) Pub. No.: US 2025/0348081 A1
(43) Pub. Date: Nov. 13, 2025

(54) ROBOT AND ROBOT CONTROL METHOD

(71) Applicant: Panasonic Intellectual Property Management Co., Ltd., Osaka (JP)

(72) Inventors: Kazuo INOUE, Osaka (JP); Nobuaki Tasaki, Osaka (JP); Shunsuke Kuhara, Osaka (JP); Masashi Otani, Osaka (JP)

(21) Appl. No.: 19/276,640

(22) Filed: Jul. 22, 2025

Related U.S. Application Data
(63) Continuation of application No. PCT/JP2024/001835, filed on Jan. 23, 2024.

(30) Foreign Application Priority Data
Feb. 10, 2023 (JP) 2023-018854

(51) Int. Cl. G05D 1/639; G05D 1/24; G05D 1/622; G05D 107/50; G05D 109/10; G05D 111/10

(52) U.S. Cl. CPC G05D 1/639; G05D 1/24; G05D 1/622; G05D 2107/50; G05D 2109/10; G05D 2111/10

(57) ABSTRACT

A robot that is mobile and includes: a controller that controls the robot; and an action unit that performs an action based on an instruction from the controller. The controller causes the action unit to perform a preliminary action before the robot starts to move in a place where the robot and a person are present together.

### CROSS REFERENCE TO RELATED APPLICATIONS

This is a continuation application of PCT International Application No. PCT/JP2024/001835 filed on Jan. 23, 2024, designating the United States of America, which is based on and claims priority of Japanese Patent Application No. 2023-018854 filed on Feb. 10, 2023. The entire disclosures of the above-identified applications, including the specifications, drawings and claims are incorporated herein by reference in their entirety.

### FIELD

The present invention relates to a movable robot and a robot control method.

### BACKGROUND

Patent Literature (PTL) 1 discloses an elevator system including an autonomous robot and an elevator group management control device. In this elevator system, based on a predicted cage state of an elevator, shape information on a robot, traveling information on the robot, it is determined whether the robot can get on the cage of the elevator, and the cage of an elevator that the robot can get on is assigned to the robot.

### CITATION LIST

### Patent Literature

PTL 1: Japanese Patent No. 6682672

### SUMMARY

### Technical Problem

For example, in a place where a robot and a person are present together, if the robot suddenly shows a large movement when starting to move, a person in the vicinity of the robot may be frightened.

Hence, the present disclosure provides a robot and the like capable of notifying beforehand that a robot is to start to move where the robot and a person are present together.

### Solution to Problem

According to an aspect of the present disclosure, a robot that is mobile includes: a controller that controls the robot; and an action unit that performs an action based on an instruction from the controller, wherein the controller causes the action unit to perform a preliminary action before the robot starts to move in a place where the robot and a person are present together.

According to another aspect of the present disclosure, a robot control method of controlling a robot that is mobile includes: causing the robot to perform a preliminary action before the robot starts to move in a place where the robot and a person are present together.

### Advantageous Effects

With the robot and the like according to an aspect of the present disclosure, it is possible to notify beforehand that a robot is to start to move.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating a block configuration of robots and a management system that includes the robots according to Embodiment 1.

FIG. 2 is a diagram illustrating an example of a mobile body that one or more persons and robots get on and get off.

FIG. 3 is a diagram illustrating an example of the robot according to Embodiment 1.

FIG. 4 is a diagram illustrating another example of the robot according to Embodiment 1.

FIG. 5 is a flowchart illustrating an action of the robot according to Embodiment 1.

FIG. 6 is a flowchart illustrating an action of a robot according to Variation 1 of Embodiment 1.

FIG. 7 is a flowchart illustrating an action of a robot according to Variation 2 of Embodiment 1.

FIG. 8 is a flowchart illustrating an action of a robot according to Variation 3 of Embodiment 1.

FIG. 9 is a diagram illustrating examples of the position relationship between persons and robots inside the mobile body.

FIG. 10 is a flowchart illustrating an action of a robot according to Variation 4 of Embodiment 1.

FIG. 11 is a flowchart illustrating an action of a robot according to Variation 5 of Embodiment 1.

FIG. 12 is a flowchart illustrating an action of a robot according to Variation 6 of Embodiment 1.

FIG. 13 is a flowchart illustrating an action of a robot according to Variation 7 of Embodiment 1.

FIG. 14 is a flowchart illustrating an action of a robot according to Variation 8 of Embodiment 1.

FIG. 15 is a flowchart illustrating an action of a robot according to Embodiment 2.

FIG. 16A is a flowchart illustrating an action of a robot according to Variation 1 of Embodiment 2.

FIG. 16B is a flowchart illustrating the action of the robot according to Variation 1 of Embodiment 2, continued from FIG. 16A.

FIG. 17 is a flowchart illustrating an action of a robot according to Embodiment 3.

FIG. 18 is a diagram illustrating another example of the management system.

FIG. 19 is a diagram illustrating another example of the management system.

FIG. 20 is a diagram illustrating another example of the management system.

FIG. 21 is a diagram illustrating Calculation example 1 of temporal getting-off/on.

FIG. 22 is a diagram illustrating Calculation example 2 of temporal getting-off/on.

### DESCRIPTION OF EMBODIMENT

Autonomous robots have been developed, and robots are gradually penetrating people's lives. In such circumstances, it is possible that persons and a robot get on together a mobile body such as the cage of an elevator. However, a person in the vicinity of a robot does not know a scheduled movement of the robot, such as when and which way the robot moves. Thus, the person may be scared of the robot. For example, if the robot suddenly shows a large movement when starting to move, a person in the vicinity of the robot may be frightened.

This problem can not only arise in a closed space such as the cage of an elevator but also readily arise where a robot and a person are present together, even outdoors or in an open indoor space. For example, in the scene in which a robot and persons cross a crosswalk together after a traffic light changes from red to green, if the robot suddenly shows a large movement, a person in the vicinity of the robot may be frightened.

In contrast, a robot according to the present disclosure performs a preliminary action to notify beforehand that the robot is to start to move, before the robot starts to move. Accordingly, it is possible to prevent a person in the vicinity of the robot from being frightened.

A robot according to Example 1 of the present disclosure is mobile and includes: a controller that controls the robot; and an action unit that performs an action based on an instruction from the controller, wherein the controller causes the action unit to perform a preliminary action before the robot starts to move in a place where the robot and a person are present together.

By causing the action unit to perform the preliminary action before the robot starts to move in this manner, it is possible to notify beforehand that the robot is to start to move.

A robot according to Example 2 of the present disclosure is the robot according to Example 1, wherein the action unit is at least one of a loudspeaker, a light, an image outputter, a movable mechanism, or a mobilizing mechanism for moving the robot.

With this configuration, it is possible to perform the preliminary action using at least one of the loudspeaker, the light, the image outputter, the movable mechanism, and the mobilizing mechanism to notify beforehand that the robot is to start to move.

A robot according to Example 3 of the present disclosure is the robot according to Example 1, wherein the controller causes the action unit to perform the preliminary action before the robot gets off a mobile body that moves in order to transport a person.

By causing the action unit to perform the preliminary action described above in this manner, it is possible to notify beforehand that the robot is to get off the mobile body.

A robot according to Example 4 of the present disclosure is the robot according to Example 3, wherein the controller outputs, to the action unit, a preliminary action signal for causing the action unit to perform the preliminary action, and the action unit performs the preliminary action upon receiving the preliminary action signal.

By outputting the preliminary action signal to the action unit in this manner, it is possible to cause the action unit to perform the preliminary action. Accordingly, it is possible to notify beforehand that the robot is to get off the mobile body.

A robot according to Example 5 of the present disclosure is the robot according to Example 4, wherein the action unit includes a mobilizing mechanism for moving the robot, and the controller drives the mobilizing mechanism to perform the preliminary action, by outputting the preliminary action signal to the action unit.

By the controller driving the mobilizing mechanism in this manner, it is possible to notify beforehand, in the form of a visual movement, that the robot is to get off the mobile body.

A robot according to Example 6 of the present disclosure is the robot according to Example 5, wherein the controller drives the mobilizing mechanism to cause the robot to get off the mobile body, by outputting a main action signal to the action unit after outputting the preliminary action signal.

Accordingly, it is possible to perform the preliminary action using the mobilizing mechanism and then cause the robot to get off the mobile body using the mobilizing mechanism. Accordingly, it is possible to notify beforehand that the robot is to get off the mobile body and then cause the robot to get off the mobile body while preventing the robot from coming into contact with its surroundings.

A robot according to Example 7 of the present disclosure is the robot according to any one of Examples 3 to 6, wherein the controller causes the action unit to perform the preliminary action, based on current position information of the mobile body and information on a location where the robot is to get off the mobile body.

Accordingly, for example, it is possible to reliably cause the robot to perform the preliminary action before the robot gets off the mobile body so as to notify beforehand that the robot is to get off the mobile body.

A robot according to Example 8 of the present disclosure is the robot according to Example 7, wherein the information on the location where the robot is to get off the mobile body is information on a scheduled getting-off location where the robot is scheduled to get off the mobile body.

Accordingly, it is possible to reliably cause the robot to perform the preliminary action before the robot gets off the mobile body, based on the information on the scheduled getting-off location of the robot.

A robot according to Example 9 of the present disclosure is the robot according to Example 7, wherein the information on the location where the robot is to get off the mobile body is information on an emergency stop location where the mobile body stops in an emergency.

Accordingly, it is possible to reliably cause the robot to perform the preliminary action before the robot gets off the mobile body, based on the information on the emergency stop location of the mobile body.

A robot according to Example 10 of the present disclosure is the robot according to any one of Examples 3 to 9, wherein the controller causes the action unit to perform the preliminary action, when a floor occupancy proportion that is a proportion of (i) a floor area occupied by the robot and a person on a floor of the mobile body to (ii) a floor area of the floor of the mobile body is higher than a predetermined threshold.

By causing the action unit to perform the preliminary action when the floor occupancy proportion is high in this manner, for example, it is possible to prevent a person present near the robot from being frightened.

A robot according to Example 11 of the present disclosure is the robot according to any one of Examples 3 to 10, wherein the controller causes the action unit to perform the preliminary action to prevent the robot from coming in contact with a person in a vicinity of the robot.

Accordingly, it is possible to prevent the robot performing the preliminary action from coming into contact with the person in the vicinity of the robot.

A robot according to Example 12 of the present disclosure is the robot according to any one of Examples 3 to 11, wherein the controller causes the action unit to perform the preliminary action to enable a person located in a moving direction of the robot to notice the preliminary action.

Accordingly, when the preliminary action is performed, it is possible to enable the person located in the moving direction of the robot to notice the preliminary action, thus preventing the robot from coming into contact with the person in the vicinity of the robot. In addition, it is possible to prevent a person present near the robot from being frightened.

A robot according to Example 13 of the present disclosure is the robot according to any one of Examples 3 to 12, wherein the controller causes the action unit to perform the preliminary action according to a type of a person in the mobile body.

Accordingly, it is possible to perform the preliminary action according to the type of the person, thus notifying beforehand that the robot is to get off the mobile body.

A robot according to Example 14 of the present disclosure is the robot according to any one of Examples 3 to 6, wherein when a person is in the mobile body, the controller causes the action unit to perform the preliminary action, and when no person is in the mobile body, the controller does not cause the action unit to perform the preliminary action.

Accordingly, it is possible to cause the action unit not to perform the preliminary action when there is no need to perform the preliminary action because no person is in the mobile body.

A robot according to Example 15 of the present disclosure is the robot according to any one of Examples 3 to 14, further comprising: a detector that detects an inside of the mobile body, wherein the controller causes the action unit to perform the preliminary action based on information obtained by the detector.

Accordingly, it is possible to cause the action unit to perform the preliminary action according to the state of the inside of the mobile body obtained with the detector.

A robot according to Example 16 of the present disclosure is the robot according to any one of Examples 3 to 15, wherein the robot is configured to move in the mobile body before the robot gets off the mobile body, and the controller causes the action unit to perform the preliminary action before the robot moves in the mobile body.

For example, by the robot moving in the mobile body before getting off the mobile body, it is possible for a person or a robot present in the mobile body to get off the mobile body efficiently. In addition, by causing the action unit to perform the preliminary action before the robot moves in the mobile body, it is possible to notify beforehand that the robot is to move in the mobile body.

A robot according to Example 17 of the present disclosure is the robot according to any one of Examples 3 to 16, wherein the robot is configured to get off and get on the mobile body again at a location that is different from a destination before getting off the mobile body at the destination, and the controller causes the action unit to perform the preliminary action before the robot moves to get off and get on again the mobile body at the location.

For example, by the robot getting off and getting on the mobile body again, it is possible for a person or a robot present in the mobile body to get off the mobile body efficiently. In addition, by causing the action unit to perform the preliminary action before the robot gets off and gets on the mobile body again, it is possible to notify beforehand that the robot is to move in the mobile body.

A robot control method according to Example 18 of the present disclosure is a method of controlling a robot that is mobile and includes: causing the robot to perform a preliminary action before the robot starts to move in a place where the robot and a person are present together.

By causing the action unit to perform the preliminary action before the robot starts to move in this manner, it is possible to notify beforehand that the robot is to start to move.

A robot control method according to Example 19 of the present disclosure is the robot control method according to Example 18, wherein the preliminary action is performed before the robot gets off a mobile body that moves in order to transport a person.

By causing the action unit to perform the preliminary action in this manner, it is possible to notify beforehand that the robot is to get off the mobile body.

Hereinafter, certain exemplary embodiments will be described with reference to the accompanying Drawings. The following embodiments are general or specific examples of the present disclosure. The numerical values, shapes, materials, constituent elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements.

Note that the respective figures are schematic diagrams and are not necessarily precise illustrations. Additionally, components that are essentially the same share like reference signs in the figures. Accordingly, overlapping explanations thereof may be omitted or simplified. Furthermore, even if figures illustrate the same object, the scales of the figures may be different for the sake of convenience.

It should also be noted that the following description may include a word indicating a relationship between constituent elements, such as “match”, a word indicating a shape of a constituent element, such as plate-shaped or rectangle, numerical values, and numerical value ranges. However, they do not mean exact meanings only. They also mean the substantially same ranges including a difference of, for example, about several % from the completely same range.

### Embodiment 1

### [Configuration of Robot and Management System]

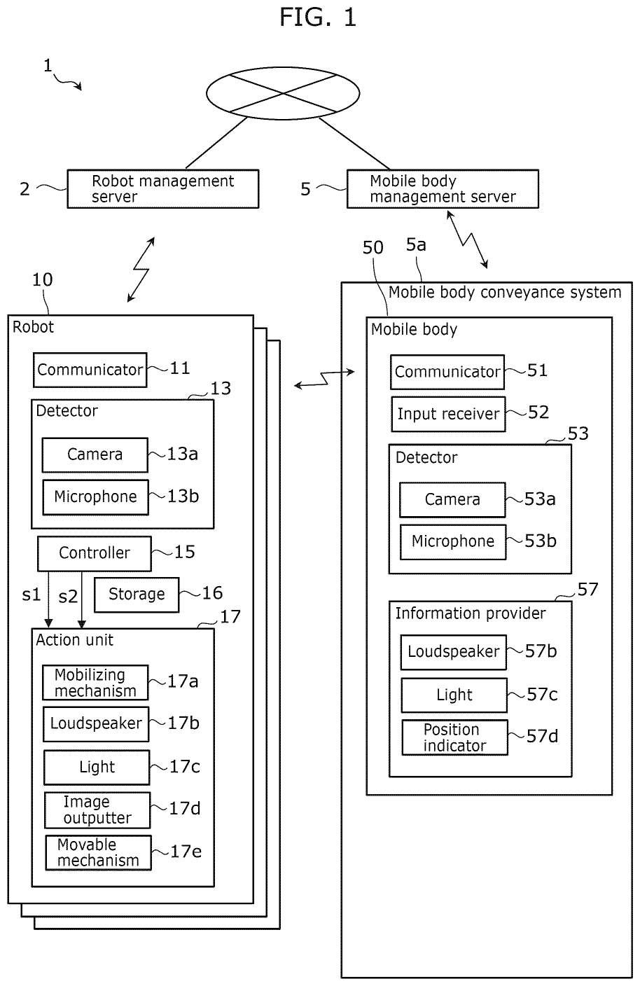

A configuration of robots and a management system according to Embodiment 1 will be described with reference to FIG. 1 to FIG. 4.

FIG. 1 is a diagram illustrating a block configuration of robots 10 and management system 1 that includes robots 10 according to Embodiment 1.

As illustrated in FIG. 1, management system 1 includes a plurality of robots 10, robot management server 2 that manages the plurality of robots 10, mobile body 50 that moves in order to transport persons, mobile body conveyance system 5a that conveys mobile body 50, and mobile body management server 5 that manages mobile body 50 and mobile body conveyance system 5a.

Each of robots 10 and robot management server 2 are capable of communicating with each other in a wireless manner. Mobile body 50 and mobile body conveyance system 5a are capable of communicating with each other in a wired or wireless manner. Mobile body conveyance system 5a and mobile body management server 5 are capable of communicating with each other in a wired or wireless manner. Robot management server 2 and mobile body management server 5 may be capable of communicating with each other over a communication network. Each of robots 10 and mobile body 50 are capable of communicating with each other in a wireless manner.

In the case where mobile body 50 has a self-driving function, management system 1 need not necessarily include mobile body conveyance system 5a. In the case where management system 1 does not include mobile body conveyance system 5a, mobile body 50 and mobile body management server 5 may be capable of communicating directly with each other in a wireless manner.

Robot management server 2 and mobile body management server 5 are each provided in a building such as, an office building, a commercial facility, or an apartment building. Robot management server 2 manages the movement of robots 10 present inside or outside the building. Mobile body management server 5 manages the movement of mobile body 50 present inside or outside the building. Note that robot management server 2 and mobile body management server 5 may be provided in a place different from places where robots 10 and mobile body 50 are present.

Mobile body 50 is, for example, a cage of an elevator, a railroad car, or a bus and includes an indoor space used for carrying persons. Mobile body 50 is a vehicle that can stop, on its way from a start point to an end point, at an intermediate point at which a person can get on or off mobile body 50. In the case where mobile body 50 is the cage of the elevator, the start point, the intermediate point, and the end point are stopping floors of the cage. In the case where mobile body 50 is the railroad car or the bus, the start point, the intermediate point, and the end point are stations or bus stops.

As illustrated in FIG. 1, mobile body 50 includes communicator 51, input receiver 52, detector 53, and information provider 57.

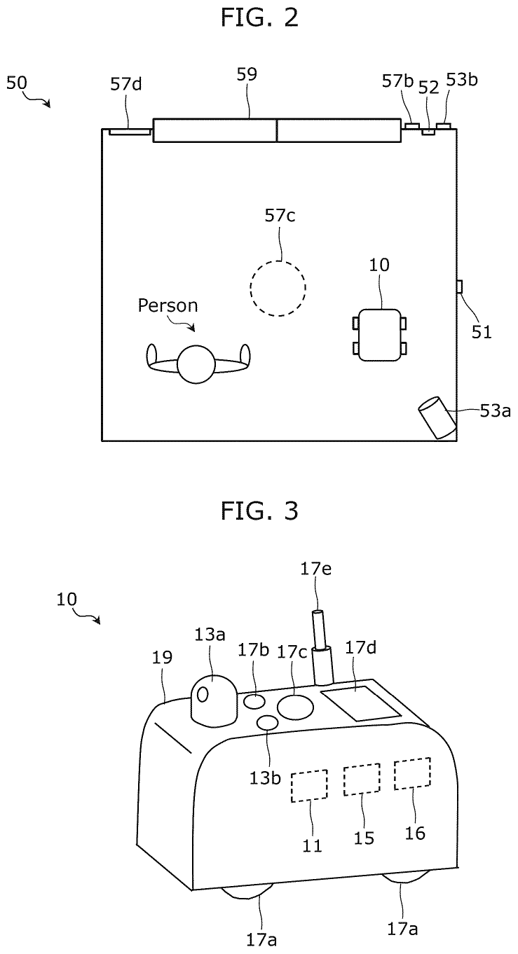

FIG. 2 is a diagram illustrating an example of mobile body 50 that persons and robots 10 can get on and get off. The figure illustrates mobile body 50 as viewed from above.

As illustrated in FIG. 2, mobile body 50 includes doorway 59. Doorway 59 is an opening through which the one or more persons or one or more robots 10 enter or exit mobile body 50. Doorway 59 is opened and closed by a door of mobile body 50.

Communicator 51 is, for example, a communication module with an antenna. Communicator 51 communicates with mobile body conveyance system 5a, mobile body management server 5, and robots 10.

Input receiver 52 is a device that receives an operative input regarding a stop location of mobile body 50. Input receiver 52 is, for example, getting-off switch that is turned on by a push by a person. Input receiver 52 is provided on an inner wall surface of mobile body 50 and beside doorway 59.

Detector 53 is a device that detects the state of the inside of mobile body 50. Detector 53 is, for example, camera 53a that detects the one or more persons and robots 10 and microphone 53b that detects sound in mobile body 50. Detector 53 is provided on the ceiling or an inner wall surface of mobile body 50.

Information provider 57 is a device that provides information to the one or more persons and one or more robots 10 in mobile body 50. Information provider 57 is loudspeaker 57b that outputs sound to the inside of mobile body 50, light 57c that illuminates the interior of mobile body 50, and position indicator 57d that displays the current position of mobile body 50. Loudspeaker 57b and light 57c are provided on the ceiling or an inner wall surface of mobile body 50. Position indicator 57d is provided on an inner wall surface of mobile body 50 and above or beside doorway 59.

For example, in the case where mobile body 50 is a cage of an elevator and mobile body conveyance system 5a is an elevator system that ascends and descends the cage, mobile body conveyance system 5a carries one or more persons and one or more robots 10 on mobile body 50 to a predetermined floor by moving mobile body 50. Note that an action of getting on mobile body 50 by robot 10 may be hereinafter referred to as “getting-on” and an action of getting off mobile body 50 by robot 10 may be hereinafter referred to as “getting-off.”

The plurality of robots 10 move to their respective predetermined points based on instructions from robot management server 2. Robots 10 are autonomously traveling robots. Robots 10 may get on and get off mobile body 50 to go to the predetermined points. Embodiment 1 will describe focusing on a scene in which robots 10 get on and get off mobile body 50.

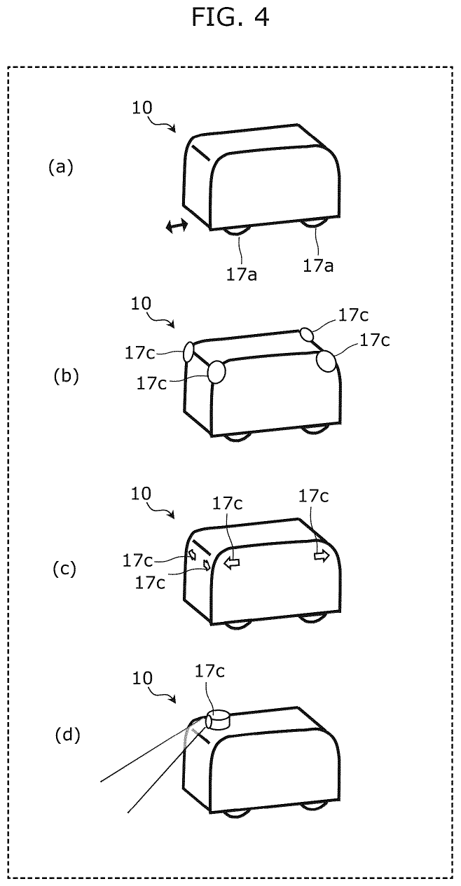

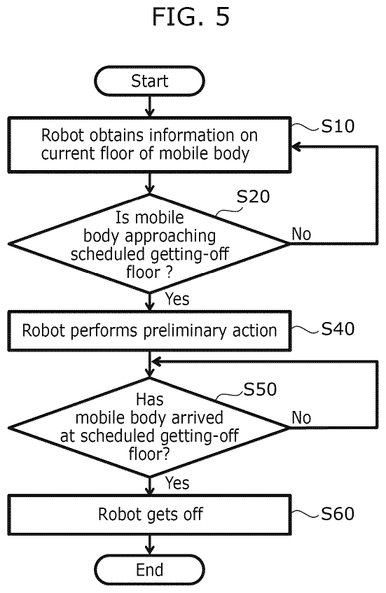

FIG. 3 is a diagram illustrating an example of robot 10 according to Embodiment 1. FIG. 4 is a diagram illustrating other examples of robot 10.

As illustrated in FIG. 1 and FIG. 3, each of robots 10 includes communicator 11, detector 13, controller 15, storage 16, and action unit 17. Robot 10 also includes housing 19 in a rectangular parallelepiped shape. Communicator 11, detector 13, controller 15, storage 16, and action unit 17 are provided in housing 19.

Communicator 11 is, for example, a communication module with an antenna. Communicator 11 communicates with robot management server 2 in a wireless manner. Communicator 11 also communicates with mobile body 50 and the other robots 10 in a wireless manner.

Detector 13 is a device that detects the state of the inside of mobile body 50. Detector 13 is, for example, camera 13a that captures the inside and the periphery of mobile body 50 and microphone 13b that detects sound in mobile body 50. Note that detector 13 may include a laser length measuring machine.

Microphone 13b is a device that detects sound emitted by the one or more persons and any other robot 10 in mobile body 50. Microphone 13b is provided on the top surface or a lateral surface of housing 19.

Camera 13a is, for example, a pan tilt zoom (PTZ) camera. Camera 13a is provided on the top surface of housing 19.

Camera 13a detects the presence or absence of one or more persons and one or more robots in mobile body 50 and a congestion state of the one or more persons and robots 10. The congestion state is expressed in the form of, for example, a floor occupancy proportion, which is the area of the one or more persons and robots 10 to a floor area of mobile body 50. The area of the one or more persons and robots 10 can be detected with camera 13a. The area of the one or more persons and robots 10 may include the area of baggage possessed by a person or robot 10. The congestion state may be given as the occupancy rate of the one or more persons and robots 10 based on the riding capacity of mobile body 50. The riding capacity of mobile body 50 is determined in advance in conformance with laws.

Camera 13a detects the placement of the one or more persons and robots 10 present in mobile body 50. The placement is given in the form of, for example, sets of plane position coordinates of the one or more persons and robots 10 present in mobile body 50. The placement includes information on the directions and the distances of the positions of, with respect to robot 10, one or more persons and another or other robots 10. The placement also includes information on the directions and the distances of the positions of, with respect to doorway 59 of mobile body 50, one or more persons and robots 10.

Camera 13a also detects the type of each of the one or more persons present in mobile body 50. The type of the person is, for example, based on the distinction of whether the person is a child, whether the person is an elderly person, whether the person is a physically impaired person, or the like. The type of the person may be based on the distinction of whether the person is a vulnerable road user.

Camera 13a also detects the current position of mobile body 50. For example, camera 13a detects the current position of mobile body 50 by capturing displayed information on the position of mobile body 50 displayed on mobile body 50. In the case where mobile body 50 is a cage of an elevator, camera 13a detects the current position of mobile body 50 by capturing the display of a floor number displayed on position indicator 57d.

These types of information detected by detector 13 are output to controller 15.

Action unit 17 performs an action based on instructions from controller 15. Action unit 17 includes mobilizing mechanism 17a for moving robot 10. Mobilizing mechanism 17a is, for example, wheels, a belt, or legs.

Action unit 17 also includes loudspeaker 17b that outputs sound, light 17c that emits light, image outputter 17d that outputs an image, and movable mechanism 17e for making part of robot 10 movable.

Controller 15 is, for example, a processor. Controller controls constituent elements included in robot 10. Storage 16 is, for example, a volatile memory and a nonvolatile memory. In storage 16, a computer program for causing robot 10 to operate and the communication address of robot 10 are saved. In addition, storage 16 stores map information on a region where robot 10 is mobile, information on a traveling route and a destination of robot 10, and information on locations where robot 10 gets on and gets off mobile body 50. These types of information are sent from robot management server 2 to robot 10 and saved in storage 16.

Based on the information output from detector 13, controller 15 determines whether robot 10 and a person are present together. When determining that robot 10 and a person are present together, controller 15 controls the movement of robot 10. For example, in the case where a person is present within a radius of 1 m from robot 10, controller 15 determines that robot 10 and the person are present together in a predetermined indoor or outdoor space.

Controller 15 also controls the movement of robot 10 based on the information saved in storage 16 and the information output from detector 13, mobile body 50, and robot management server 2.

In the present embodiment, before robot 10 gets off mobile body 50, controller 15 causes action unit 17 to perform a preliminary action for getting off. For example, controller 15 outputs, to action unit 17, preliminary action signal s1 for causing action unit 17 to perform the preliminary action. Receiving preliminary action signal s1, action unit 17 performs the preliminary action.

Preliminary action signal s1 includes information for causing action unit 17 to perform the preliminary action so that robot 10 does not come in contact with a person in the vicinity of robot 10. preliminary action signal s1 also includes information for causing action unit 17 to perform the preliminary action so as to enable one or more persons located in the moving direction of robot 10 to notice the preliminary action. The one or more persons positioned in the moving direction are one or more persons present in a direction in which robot 10 moves when robot 10 gets off. For example, the one or more persons positioned in the moving direction are located between robot 10 and doorway 59. preliminary action signal s1 also includes information for causing action unit 17 to perform the preliminary action according to the type of the person in mobile body 50.

For example, the preliminary action is an action in which robot 10 moves a short distance with mobilizing mechanism 17a. The preliminary action may be an action that is an imitation of a small action of a human before performing a main action. That is, the preliminary action may be an action that notifies the main action in advance, in a human-like manner. The preliminary action may be an action smaller than the main action or a preparatory action before the main action is performed. Specifically, the preliminary action may be a straight line action in which robot 10 moves forward and backward within the range from 1 cm to 2 cm (see (a) in FIG. 4) or may be a straight line action in which robot 10 moves left and right within the range from 1 cm to 2 cm. The preliminary action may be a rotary action in which robot 10 moves clockwise and counterclockwise within the range from 1 cm to 2 cm (or from 1° to 5°) on the outermost circumference of robot 10. The preliminary action may be an action of free-spinning of a wheel, which is an example of mobilizing mechanism 17a.

The preliminary action may be the vibration of robot 10 generated by movable mechanism 17e such as a vibrator. This preliminary action may be a continuous vibration of robot 10 or intermittent vibration of robot 10. The preliminary action may be part of an operative action of robot 10 with movable mechanism 17e such as a robot arm. This preliminary action may be an action of operating a stretching mechanism such as stretching an arm of robot 10 being the robot arm or stretching a neck from a body of robot 10. This preliminary action may be an action of rotating movable mechanism 17e.

The preliminary action may be outputting an utterance or sound from loudspeaker 17b. The utterance output from loudspeaker 17b may be a voice announcement such as “I will get off at the next stop,” “I am about to move,” “Please let me through,” “I am about to shift to the right,” or “I am about to go forward.” The sound output from loudspeaker 17b is desirably a sound that calls for attention without unexpectedly frightening a person in the vicinity of robot 10. The sound output from loudspeaker 17b may be a sound such as pop-pop, choo-choo, yip-yip, tick-tack, vroom-vroom, brrm, hatehate, yoyoyo, or heave-ho. Controller 15 may cause robot 10 to perform the preliminary action by causing loudspeaker 17b to output sound while rotating loudspeaker 17b. Controller 15 may control action unit 17 such that sound is emitted from loudspeaker 17b that is located in a moving direction in which robot 10 moves in the preliminary action.

The preliminary action may be turning on or flashing light 17c or controlling the color or the lighting of light 17c. Controller 15 may cause robot 10 to perform the preliminary action by turning on and flashing a plurality of lights 17c located at four corners of robot 10 (see (b) in FIG. 4). Controller 15 may turn off lights 17c when mobile body 50 is stationary. Controller 15 may cause robot 10 to perform the preliminary action by turning on and flashing lights 17c forward, backward, right, and left arrows (see (c) in FIG. 4). Controller 15 may cause robot 10 to perform the preliminary action by causing light 17c to emit light to the surroundings while rotating light 17c. Controller 15 may cause robot 10 to perform the preliminary action by illuminating the floor ahead of robot 10 in the moving direction with the light of light 17c (see (d) in FIG. 4).

The preliminary action may be displaying an image output from image outputter 17d. Image outputter 17d is, for example, a display device, a projector, or a projector for laser mapping. Controller 15 may cause robot 10 to perform the preliminary action by causing image outputter 17d to display an image of a face, a picture, characters, or the like. Controller 15 may cause robot 10 to perform the preliminary action by changing these images. Controller 15 may cause robot 10 to perform the preliminary action by projecting a video and characters onto a wall using a projector.

The preliminary action may be the combination of the actions described above. The preliminary action may be a going-and-returning action with an outgoing route and an incoming route or may be a one-way action with only an outgoing route. The execution of the preliminary action may last for, for example, 1 second to 5 seconds.

These preliminary actions are executed when mobile body 50 approaches a location where robot 10 is to get off mobile body 50.

Controller 15 causes action unit 17 to perform the preliminary action, based on the current position information on mobile body 50 and information on the location where robot 10 is to get off mobile body 50.

Controller 15 obtains the current position information on mobile body 50 based on the information output from detector 13. Note that controller 15 may obtain the current position information on mobile body 50 by receiving the current position information on mobile body 50 issued from mobile body 50 via communicator 11.

The information on the location where robot 10 is to get off mobile body 50 is information on a scheduled getting-off location where robot 10 is scheduled to get off mobile body 50. Controller 15 obtains the information on the scheduled getting-off location from storage 16.

The preliminary action of robot 10 is executed before the getting-off action of robot 10. For example, robot 10 performs the preliminary action before mobile body 50 arrives the scheduled getting-off location of robot 10. The “before mobile body 50 arrives the scheduled getting-off location” means, for example, a period from leaving a stop location previous to the scheduled getting-off location to arriving at the scheduled getting-off location. During this period, robot 10 notifies its surroundings that robot 10 is scheduled to get off at a location where mobile body 50 is scheduled to stop next.

Note that robot 10 may perform the preliminary action after mobile body 50 arrives the scheduled getting-off location of robot 10. For example, robot 10 performs the preliminary action during a period from arriving at the scheduled getting-off location to opening of the door at doorway 59. During this period, robot 10 notifies its surroundings that robot 10 is scheduled to get off at a location where mobile body 50 is now stopping.

Robot 10 determines whether it has arrived at the scheduled getting-off location by detecting the display on position indicator 57d with detector 13 or based on the position information on mobile body 50 sent from mobile body 50.

After performing the preliminary action and arriving at the scheduled getting-off location, robot 10 performs getting-off, which is a main action. For example, controller 15 drives mobilizing mechanism 17a to cause robot 10 to get off mobile body 50 by outputting main action signal s2 to action unit 17 after outputting preliminary action signal s1. A time from outputting preliminary action signal s1 to outputting main action signal s2 is, for example, from 3 seconds to 10 seconds, which is however changed according to the state of mobile body 50.

The getting-off action may be an action fully different from the preliminary action or may be an action similar to the preliminary action. The getting-off action may include, in addition to driving mobilizing mechanism 17a, activating loudspeaker 17b, light 17c, image outputter 17d, and movable mechanism 17e.

Robot 10 according to the present embodiment is a robot capable of getting on and getting off mobile body 50 that moves in order to transport one or more persons. Robot 10 includes controller 15 that controls robot 10 and action unit 17 that performs an action based on instructions from controller 15. Before robot 10 gets off mobile body 50, controller 15 causes action unit 17 to perform the preliminary action for getting off. By causing action unit 17 to perform the preliminary action in this manner, it is possible to notify beforehand that robot 10 is to get off mobile body 50.

The above has described focusing on the configuration of robot 10 for solving the problems that can arise in a closed space such as mobile body 50. However, even outdoors or in an open indoor space, if robot 10 suddenly shows a large movement where robot 10 and one or more persons are present together, one or more persons in the vicinity of robot 10 are frightened. To solve this, robot 10 according to the present embodiment has the configuration described below.

Robot 10 according to the present embodiment is a mobile robot. Robot 10 includes controller 15 that controls robot 10 and action unit 17 that performs an action based on instructions from controller 15. Where robot 10 and one or more persons are present together, controller 15 causes action unit 17 to perform the preliminary action before robot 10 starts to move. By causing action unit 17 to perform the preliminary action before robot 10 starts to move in this manner, it is possible to notify beforehand that robot 10 is to start to move.

### [Action of Robot]

The operation of robot 10 according to Embodiment 1 will be described. The following describes the case where mobile body 50 is a cage of an elevator, as an example.

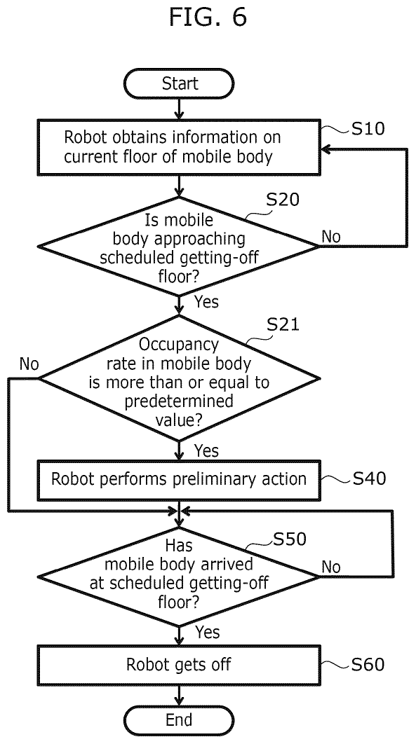

FIG. 5 is a flowchart illustrating an action of robot 10.

First, robot 10 obtains information on the current floor of mobile body 50 (step S10). For example, robot 10 obtains the information on the current floor of mobile body 50 by detecting the display on position indicator 57d with detector 13 or based on the position information on mobile body 50 sent from mobile body 50.

Next, robot 10 determines whether mobile body 50 is approaching a scheduled getting-off floor of robot 10 (step S20). The scheduled getting-off floor is stored in storage 16 of robot 10 in advance. Whether mobile body 50 is approaching the scheduled getting-off floor is determined based on, for example, whether mobile body 50 has passed a floor just previous to the scheduled getting-off floor. Whether mobile body 50 is approaching the scheduled getting-off floor may be determined based on a distance or a time to arrive at the scheduled getting-off floor from the current position.

When robot 10 determines that mobile body 50 is not approaching the scheduled getting-off floor (No in S20), the operation returns to the previous step, where the process of step S10 is performed.

When determining that mobile body is approaching the scheduled getting-off floor (Yes in S20), robot 10 performs the preliminary action for getting off (step S40). At this time, robot 10 performs the preliminary action at least once. Note that robot 10 may perform the preliminary action a plurality of times or may perform the preliminary action for a given period of time. Robot 10 may continuously perform the preliminary action until arriving at the scheduled getting-off floor.

When finishing the preliminary action, robot 10 determines whether mobile body 50 has arrived at the scheduled getting-off floor (step S50). For example, robot 10 obtains the information on whether mobile body 50 has arrived at the scheduled getting-off floor, by detecting the display on position indicator 57d with detector 13 or based on the position information on mobile body 50 sent from mobile body 50.

When determining that mobile body 50 has not arrived at the scheduled getting-off floor (No in S50), robot 10 performs the process of step S50 again.

When determining that mobile body 50 has arrived at the scheduled getting-off floor (Yes in S50), robot 10 gets off from mobile body 50 (step S60). For example, robot 10 performs the getting-off action, which is the main action, by driving mobilizing mechanism 17a. Through the steps illustrated in FIG. 5, the preliminary action and the getting-off action of robot 10 are finished.

Note that robot 10 may perform the following actions in the preliminary action or the main action to provide the notification of the moving direction of robot 10.

For example, robot 10 may provide the notification of the moving direction of robot 10 by announcing that, for example, robot 10 is going to move forward, right, diagonally right at 45°, with the loudspeaker. Robot 10 may provide the notification of the moving direction of robot 10 by using a plurality of loudspeakers to make a sound in forward, backward, right, and left directions or in eight direction or by causing a loudspeaker with a megaphone disposed on its top surface to make a sound while rotating the loudspeaker with a megaphone. Robot 10 may provide the notification of the moving direction of robot 10 by turning on or flashing a plurality of lights, by turning on or flashing forward, backward, right, and left arrow indicators, or by irradiating the floor ahead of robot 10 in the moving direction with its light. Robot 10 may provide the notification using both the loudspeaker and the light. In the case where a plurality of robots 10 are present in mobile body 50, the plurality of robots 10 may cooperate together to notify the moving direction to the surroundings. Robot 10 may output a notification indicating signal to mobile body 50 to cause information provider 57 of mobile body 50 to provide the notification of the moving direction of robot 10.

Robot 10 may make a sound at a timing different from that of an announcement about the operation situation of mobile body 50. For example, if the sound “The door of mobile body 50 will open” emitted from mobile body 50 and the sound indicating the preliminary action emitted from robot 10 are output at the same time, it is difficult for one or more persons in mobile body 50 to recognize the sound indicating the preliminary action. Thus, robot 10 may perform the preliminary action at a timing different from that of an operation announcement from mobile body 50. Robot 10 may perform the preliminary action not using sound, for example, an action with light 17c, image outputter 17d, or movable mechanism 17e during the period of the operation announcement in mobile body 50.

When mobile body 50 comes to its last stop, for example, when mobile body 50 comes to a top floor or a bottom floor, robot 10 always gets off from mobile body 50. Thus, one or more persons in mobile body 50 are not often frightened by the getting-off action of robot 10. In this case, robot 10 need not perform the preliminary action and may get off from mobile body 50 after all persons get off mobile body 50.

### Variation 1 of Embodiment 1

The operation of robot 10 according to Variation 1 of Embodiment 1 will be described. In Variation 1, an example in which the preliminary action is performed according to the occupancy rate in mobile body 50 will be described.

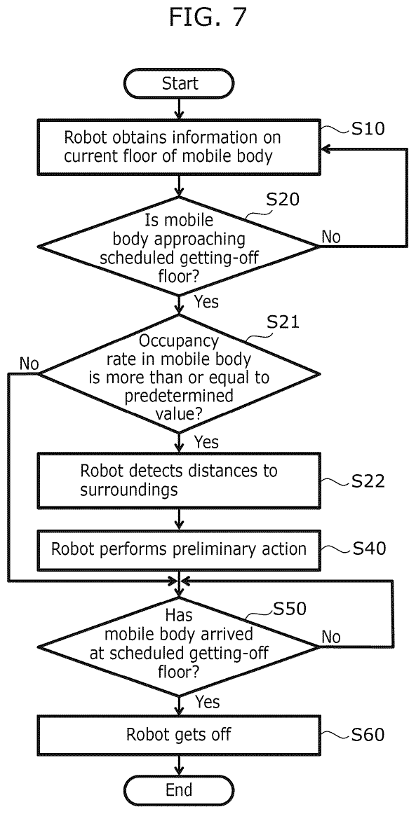

FIG. 6 is a flowchart illustrating an action of robot 10 according to Variation 1.

First, robot 10 obtains information on the current floor of mobile body 50 (step S10). Next, robot 10 determines whether mobile body 50 is approaching a scheduled getting-off floor of robot 10 (step S20). When determining that mobile body 50 is not approaching the scheduled getting-off floor, the operation returns to step S10.

In Variation 1, when determining that mobile body 50 is approaching the scheduled getting-off floor (Yes in S20), robot 10 determines whether the occupancy rate of one or more persons and robots 10 in mobile body 50 is more than or equal to a predetermined value (step S21). The predetermined value for the occupancy rate of the one or more persons and robots 10 is, for example, 60%. Note that, in step S21, the determination may be made with a floor occupancy proportion instead of the occupancy rate. The floor occupancy proportion is a value calculated from the floor area of mobile body 50 as a denominator and the area of the one or more persons and robots 10 as a numerator.

When the occupancy rate is less than the predetermined value (No in S21), the one or more persons are less likely to be frightened by the getting-off action of robot 10. Thus, robot 10 performs the process of step S50 without performing the preliminary action.

When the occupancy rate is more than or equal to the predetermined value (Yes in S21), robot 10 performs the preliminary action for getting off (step S40). For example, when the occupancy rate in mobile body 50 is high (e.g., greater than or equal to 60%), robot 10 performs the preliminary action so as not to come in contact with a person.

Specifically, robot 10 moves in a direction that is different from a direction in which someone is present. Note that robot 10 may perform the preliminary action using loudspeaker 17b, light 17c, image outputter 17d, and movable mechanism 17e. Note that robot 10 may perform the preliminary action in the case where the occupancy rate in mobile body 50 is less than the predetermined value. In this case, robot 10 may perform an action of moving such that robot 10 is not to come in contact with a person or may perform, in addition to the action of moving, the preliminary action using loudspeaker 17b, light 17c, image outputter 17d, and movable mechanism 17e.

After finishing the preliminary action, robot 10 executes the process of the next steps S50 and S60. The process of steps S50 and S60 is the same as in Embodiment 1. Through the steps illustrated in FIG. 6, the preliminary action and the getting-off action of robot 10 are finished.

As seen from the above, robot 10 according to Variation 1 determines the necessity of the preliminary action based on whether the occupancy rate in mobile body 50 is more or less than the predetermined value. For example, in the case where the occupancy rate in mobile body 50 is low, even when robot 10 moves after mobile body 50 arrives at the scheduled getting-off floor of robot 10, one or more persons in the vicinity of robot 10 can avoid moving robot 10. On the other hand, in the case where the occupancy rate in mobile body 50 is high, when robot 10 moves after mobile body 50 arrives at the scheduled getting-off floor of robot 10, one or more persons in the vicinity of robot 10 cannot avoid moving robot 10. Thus, in the case of a high occupancy rate, robot 10 performing the preliminary action to notify one or more persons in the vicinity of robot 10 beforehand that robot 10 is scheduled to get off from mobile body 50 enables robot 10 to get off from mobile body 50 smoothly.

Note that in the case where robot 10 has only a function of moving as its function of the action, robot 10 may output a notification indicating signal to mobile body 50 to cause information provider 57 of mobile body 50 to provide the notification that robot 10 is scheduled to get off from mobile body 50. Robot 10 may output the notification indicating signal to mobile body 50 via robot management server 2 and mobile body management server 5 to cause information provider 57 of mobile body 50 to provide the notification that robot 10 is scheduled to get off from mobile body 50. In this case, mobile body 50 may irradiate robot 10 with light like spotlight from the ceiling of mobile body 50 to provide the notification that robot 10 is scheduled to get off from mobile body 50. Mobile body 50 may dim the entire inside of mobile body 50 and irradiate robot 10 with light so as to make it easy for one or more persons to recognize robot 10 scheduled to get off from mobile body 50.

### Variation 2 of Embodiment 1

The operation of robot 10 according to Variation 2 of Embodiment 1 will be described. In Variation 2, an example in which the preliminary action is performed so that robot 10 does not come in contact with one or more persons in the vicinity of robot 10 will be described.

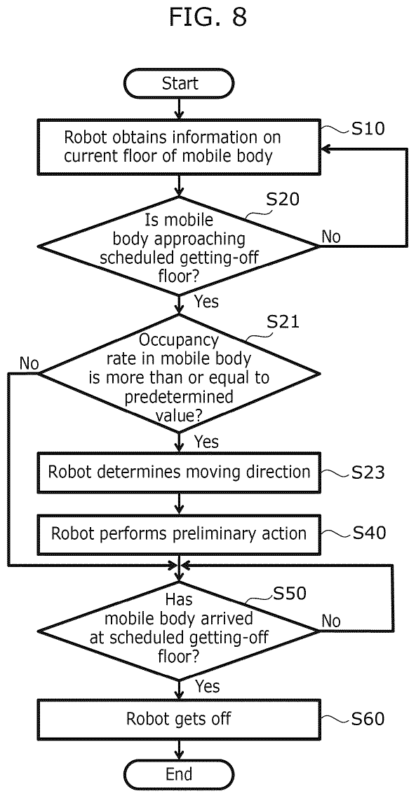

FIG. 7 is a flowchart illustrating an action of robot 10 according to Variation 2.

First, robot 10 obtains information on the current floor of mobile body 50 (step S10). Next, robot 10 determines whether mobile body 50 is approaching a scheduled getting-off floor of robot 10 (step S20). Next, robot 10 determines whether the occupancy rate of one or more persons and robots 10 in mobile body 50 is more than or equal to a predetermined value (step S21). When the occupancy rate is less than the predetermined value, the operation proceeds to step S50.

In Variation 2, when the occupancy rate is more than or equal to the predetermined value (Yes in S21), robot 10 detects the distances to its surroundings (step S22). Robot 10 detects a gap between robot 10 and one or more persons or robots in the vicinity of robot 10 with, for example, detector 13.

After detecting the distances to the surroundings, robot 10 performs the preliminary action for getting off (step S40). At this time, robot 10 performs the preliminary action in a direction or at a distance in which no contact occurs so that robot 10 does not come in contact with the one or more persons and robots 10 in the vicinity of robot 10. For example, in order to provide the notification such that robot 10 does not come in contact with anyone in the vicinity of robot 10 when robot 10 moves, it is necessary to determine a direction and a gap in which robot 10 can move before the movement. Robot 10 may perform the preliminary action in a direction in which the gap is present, rather than in a direction in which robot 10 travels in getting-off from mobile body 50.

After finishing the preliminary action, robot 10 executes the process of the next steps S50 and S60. Through the steps illustrated in FIG. 7, the preliminary action and the getting-off action of robot 10 in Variation 2 are finished.

### Variation 3 of Embodiment 1

The operation of robot 10 according to Variation 3 of Embodiment 1 will be described. In Variation 3, an example in which the preliminary action is performed for one or more persons present in the moving direction of robot 10 will be described.

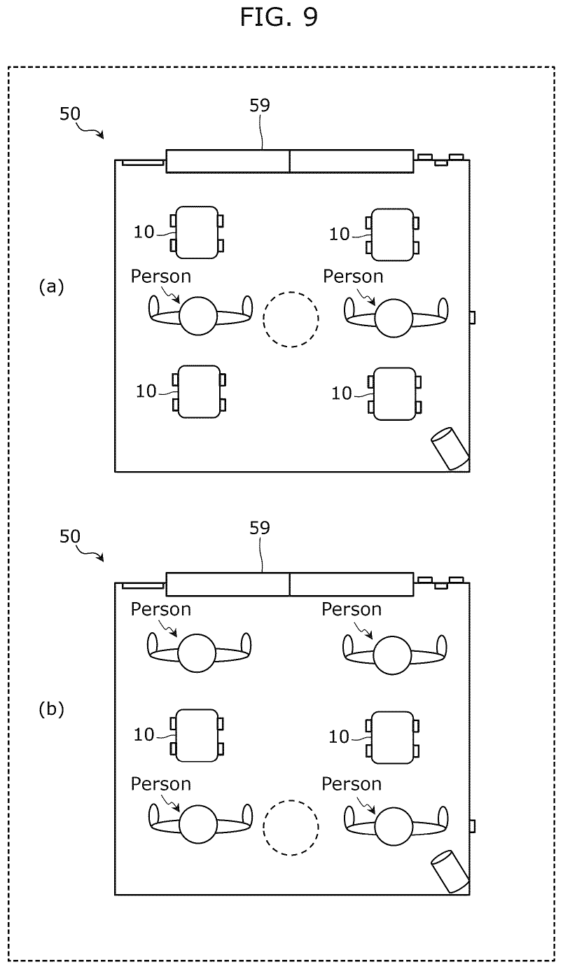

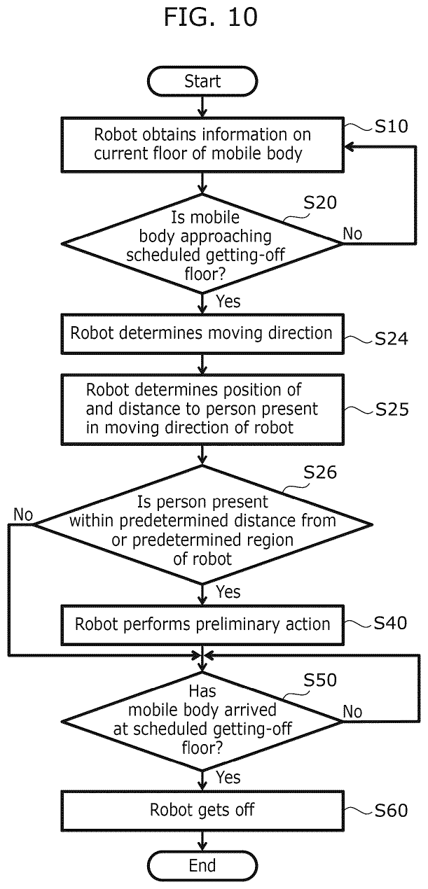

FIG. 8 is a flowchart illustrating an action of robot 10 according to Variation 3. FIG. 9 is a diagram illustrating examples of the position relationship between persons and robots 10 inside mobile body 50. Steps S10 to S21 are the same as in Variation 2.

In Variation 3, when the occupancy rate is more than or equal to a predetermined value (Yes in S21), robot 10 detects the surroundings to determine the moving direction of robot 10 (step S23). Robot 10 detects doorway 59, and one or more persons and another or other robots 10 with, for example, detector 13 to determine the moving direction.

After determining the moving direction, robot 10 performs the preliminary action for getting off (step S40). At this time, robot 10 performs the preliminary action for one or more persons present in the moving direction of robot 10. The one or more persons present in the moving direction are one or more persons present in a direction in which robot 10 moves when robot 10 gets off. For example, the one or more persons present in the moving direction are located between robot 10 and doorway 59 (see (a) and (b) in FIG. 9). In order to perform the preliminary action for the one or more persons present in the moving direction of robot 10, it is necessary to determine the moving direction of robot 10 and the distance to one or more persons present in the moving direction before the movement. Robot 10 may adjust how to perform the preliminary action by changing the orientation or position of robot 10 according to the moving direction (or a direction to doorway 59) and the distance to the one or more persons.

After finishing the preliminary action, robot 10 executes the process of the next steps S50 and S60. Through the steps illustrated in FIG. 8, the preliminary action and the getting-off action of robot 10 in Variation 3 are finished.

### Variation 4 of Embodiment 1

The operation of robot 10 according to Variation 4 of Embodiment 1 will be described. In Variation 4, an example in which the preliminary action is performed according to one or more persons present in the moving direction of robot 10, the width of the moving route of robot 10, and the like will be described.

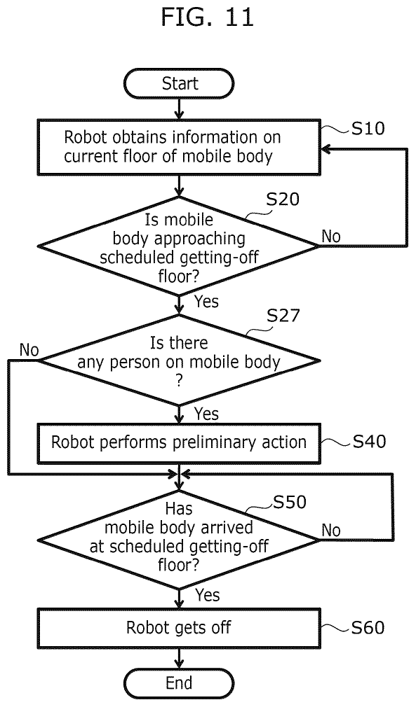

FIG. 10 is a flowchart illustrating an action of robot 10 according to Variation 4. Steps S10 to S20 are the same as in Embodiment 1.

In Variation 4, after step S20, robot 10 determines its moving direction (step S24). The moving direction of robot 10 is determined based on the detection of doorway 59, and one or more persons and another or other robots 10 with, for example, detector 13.

Next, robot 10 determines the position of and the distance to one or more persons present in the moving direction of robot 10 (step S25). The position of and distance to the one or more persons are determined based on the detection of the one or more persons with, for example, detector 13. Note that the determination as to whether the occupancy rate is high or low is not made in Variation 4. This is because, for example, a person may be frightened when robot 10 moves if robot 10 is too close to the person even when the occupancy rate is low. Therefore, in Variation 4, the necessity of the preliminary action is determined based on the position of and the distance to the one or more persons, irrespective of the occupancy rate.

Robot 10 determines whether the one or more persons present in the moving direction are present within a predetermined distance from robot 10 or a predetermined region of robot 10 (step S26). The predetermined distance is a distance sufficient for performing the preliminary action. For example, the predetermined distance is 50 cm. The predetermined region is a region necessary for robot 10 to get off from mobile body 50. The predetermined region is determined based on, for example, the length and the width of the moving route of robot 10 in getting-off from mobile body 50. A person present within the predetermined distance is apt to come in contact with robot 10 performing the preliminary action, and a person present within the predetermined region is apt to come in contact with robot 10 getting-off from mobile body 50.

When the one or more persons present in the moving direction are absent within the predetermined distance from robot 10 or the predetermined region of robot 10 (No in S26), robot 10 executes the process of next step S50.

When the one or more persons present in the moving direction are present within the predetermined distance from robot 10 or the predetermined region of robot 10 (Yes in S26), robot 10 performs the preliminary action for getting off mobile body 50 (step S40). At this time, robot 10 performs the preliminary action for one or more persons present in the moving direction. Robot 10 may adjust how to perform the preliminary action by changing the orientation or position of robot 10 according to the distance to the one or more persons, the moving direction of robot 10, and the width of the moving route of robot 10.

After finishing the preliminary action, robot 10 executes the process of the next steps S50 and S60. Through the steps illustrated in FIG. 10, the preliminary action and the getting-off action of robot 10 in Variation 4 are finished.

Note that, in step S40, robot 10 may change the preliminary action according to the position relationship and the orientation relationship between robot 10 and the one or more persons in mobile body 50.

For example, a person in an immediate vicinity of doorway 59 is highly likely to get off mobile body 50 prior to robot 10. For this reason, robot 10 may perform such a preliminary action that neither troubles nor interferes with one or more persons who are present close to doorway 59 (e.g., a preliminary action with outputting no sound). At the same time, there may be a person who is present near robot 10 and gets off mobile body 50 at a floor later than a floor at which robot 10 is to get off mobile body 50. For this reason, robot 10 may perform such a preliminary action that is easily perceived by one or more persons present near robot 10 (e.g., a preliminary action with outputting sound).

For example, it is not necessary to especially cause a person facing robot 10 to face robot 10. Thus, robot 10 may perform such a preliminary action that neither troubles nor interferes with the person. In contrast, it is desirable to cause a person showing their back to robot 10 to face robot 10. Thus, robot 10 may perform such a preliminary action that is easily perceived by the person.

If robot 10 suddenly makes a loud sound, an intensive movement, or the like in a person's face, the person is more frightened by robot 10 than robot 10 behind the person doing the same thing. Thus, how to perform the preliminary action may be changed according to a direction in which the person faces.

Robot 10 may change the preliminary action according to the height position of the head of a person to be notified.

For example, since the eyes and ears of a human are on their head, it is difficult for the human to perceive the notification unless the notification is directed to the head. A person distant from robot 10 may be hidden behind a person beside robot 10 and may be unaware of the notification from robot 10. For this reason, robot 10 may perform the preliminary action with output sound being directed, by changing the height position or the orientation of loudspeaker 17b for example, to the head of a person to be notified. Robot 10 may operate movable mechanism 17e that can be seen by a person to be notified or irradiating the head of the person or the ceiling of mobile body 50 with light of light 17c. Robot 10 may raise light 17c and image outputter 17d to a height at which the person to be notified can see light 17c and image outputter 17d. Robot 10 may perform the preliminary action with light 17c provided on the top surface of housing 19 being turned on so as to enable even a person distant from robot 10 to notice robot 10.

### Variation 5 of Embodiment 1

The operation of robot 10 according to Variation 5 of Embodiment 1 will be described. In Variation 5, an example in which the preliminary action is performed according to the presence or absence of one or more persons in mobile body 50 will be described.

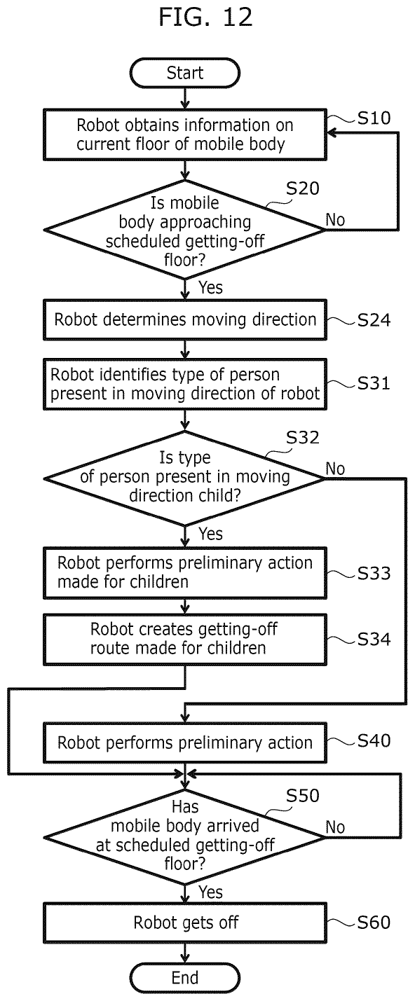

FIG. 11 is a flowchart illustrating an action of robot 10 according to Variation 5. Steps S10 to S20 are the same as in Embodiment 1.

In Variation 5, whether any person is on mobile body 50 is determined after step S20 (step S27). Robot 10 detects whether any person is on mobile body 50 with, for example, detector 13. When at least one person is on mobile body 50, robot 10 determines that at least person is on mobile body 50. When only one or more robots 10 are on mobile body 50, robot 10 determines that no person is on mobile body 50.

When determining that no person is on mobile body 50 (No in S27), robot 10 executes the process of step S50.

When determining that any person is on mobile body 50 (Yes in S27), robot 10 performs the preliminary action for getting off (step S40).

After finishing the preliminary action, robot 10 executes the process of the next steps S50 and S60. Through the steps illustrated in FIG. 11, the preliminary action and the getting-off action of robot 10 in Variation 5 are finished.

### Variation 6 in Embodiment 1

The operation of robot 10 according to Variation 6 of Embodiment 1 will be described. In Variation 6, a preliminary action in the case where a person present in the moving direction of robot 10 is a child will be described. For example, a usual preliminary action may interest a child to cause the child to hinder the traveling of robot 10. For this reason, in order for robot 10 to get off from mobile body 50 smoothly, a movement to avoid a child is needed.

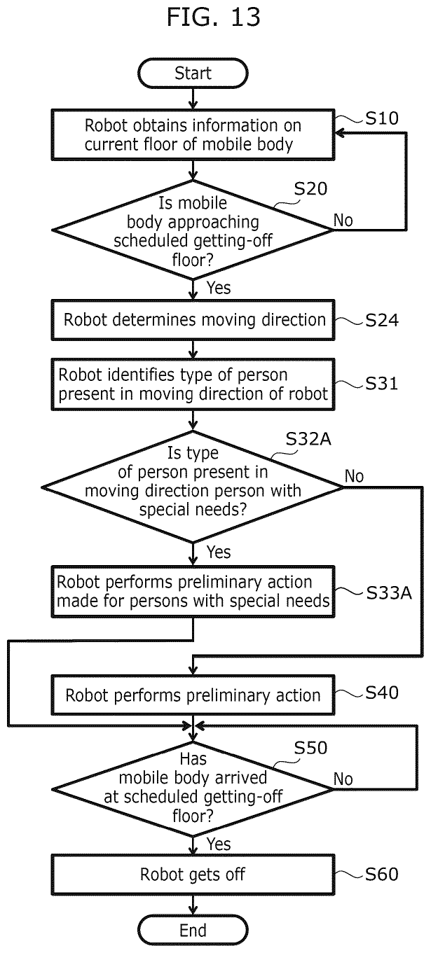

FIG. 12 is a flowchart illustrating an action of robot 10 according to Variation 6. Steps S10 to S20 and S24 are the same as in Variation 4.

In Variation 6, after step S24, robot 10 identifies the type of a person present in the moving direction (step S31). Robot 10 detects a person present in the moving direction with detector 13 and identifies the type of the person. The type of the person is, for example, based on the distinction of whether the person is a child, whether the person is an elderly person, whether the person is a physically impaired person, or the like.

Robot 10 determines whether the type of the person present in the moving direction is child (step S32). When the type of the person present in the moving direction is not child (No in S32), the operation proceeds to step S40, where robot 10 performs the usual preliminary action.

When the type of the person present in the moving direction is child (Yes in S32), robot 10 performs a preliminary action made for children (step S33). The preliminary action made for children is a preliminary action that does not interest the children. The preliminary action made for children is desirably a preliminary action that can be understood by only adults.

After finishing the preliminary action made for children, robot 10 creates a getting-off route made for children (step S34). The getting-off route made for children is, for example, a route that detours robot 10 around the position of a child. In this case, the getting-off route is different from an original scheduled getting-off route because a child is on the original scheduled getting-off route.

After finishing step S34, robot 10 executes the process of the next steps S50 and S60. Through the steps illustrated in FIG. 12, the preliminary action and the getting-off action of robot 10 in Variation 6 are finished.

### Variation 7 in Embodiment 1

The operation of robot 10 according to Variation 7 of Embodiment 1 will be described. In Variation 7, a preliminary action in the case where a person present in the moving direction of robot 10 is a physically impaired person will be described.

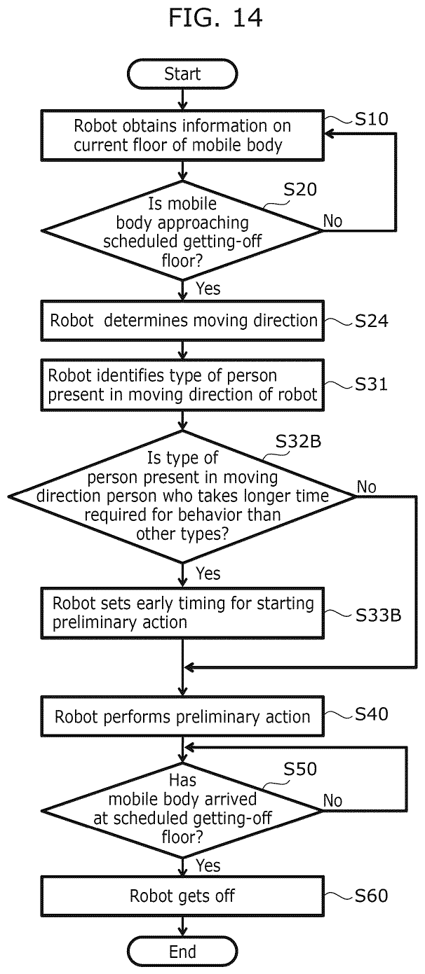

FIG. 13 is a flowchart illustrating an action of robot 10 according to Variation 7. Steps S10 to S31 are the same as in Variation 6.

In Variation 7, after step S31, robot 10 determines whether the type of a person present in the moving direction is physically impaired person (step S32A). When the type of the person present in the moving direction is not physically impaired person (No in S32A), the operation proceeds to step S40, where robot 10 performs the usual preliminary action.

When the type of the person present in the moving direction is physically impaired person (Yes in S32A), robot 10 performs a preliminary action made for physically impaired persons (step S33A). The preliminary action made for physically impaired persons is notification means that is easy for physically impaired persons to understood. For example, when detecting a white cane user, robot 10 performs the preliminary action with sound or vibration. Robot 10 may perform two or more types of preliminary action that can be understood by a visually impaired person or a hearing-impaired person.

After finishing the preliminary action made for physically impaired persons, robot 10 executes the process of the next steps S50 and S60. Through the steps illustrated in FIG. 13, the preliminary action and the getting-off action of robot 10 in Variation 7 are finished.

### Variation 8 in Embodiment 1

The operation of robot 10 according to Variation 8 of Embodiment 1 will be described. In Variation 8, an example in which the timing for starting the preliminary action is changed according to the type of a person will be described.

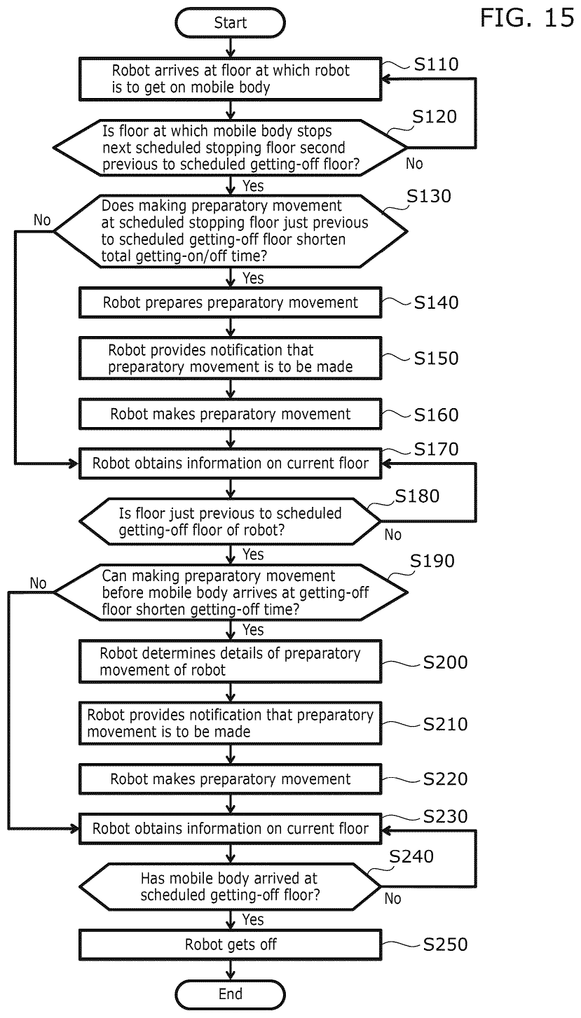

FIG. 14 is a flowchart illustrating an action of robot 10 according to Variation 8. Steps S10 to S31 are the same as in Variation 6.

In Variation 8, after step S31, robot 10 determines whether a person present in the moving direction is of a type of persons who take a longer time required for behavior than usual persons (step S32B). Examples of the persons who take a longer time required for behavior than usual persons include an elderly person, a wheelchair user, a crutch user, a white cane user, and a stroller user. A vulnerable road user is included in the persons who take a longer time required for behavior than usual persons.

When the person present in the moving direction is not of the type of the persons who take a longer time required for behavior than usual persons (No in S32B), the operation proceeds to step S40, where robot 10 performs the usual preliminary action.

When the person present in the moving direction is of the type of the persons who take a longer time required for behavior than usual persons (Yes in S32B), robot 10 sets an early timing for starting the preliminary action (step S33B). The timing for starting the preliminary action is set to, for example, a timing at which the door is closed at a stopping floor just previous to the scheduled getting-off floor. The timing for starting the preliminary action may be determined based on the moving speed and the moving duration of mobile body 50 from the just previous stopping floor to the scheduled getting-off floor.

After step S33B, robot 10 performs the preliminary action (step S40). At this time, robot 10 performs the preliminary action at the timing set in step S33B for the person who takes a longer time required for behavior than usual persons. For example, in the case where the person who takes a longer time required for behavior than usual persons is a stroller user, robot 10 moves at a speed at which robot 10 does not wake a baby sleeping in the stroller. In contrast, robot 10 performs the preliminary action at a usual timing for a person who does not take a longer time required for behavior than usual persons.

After finishing the preliminary action in step S40, robot 10 executes the process of the next steps S50 and S60. Through the steps illustrated in FIG. 14, the preliminary action and the getting-off action of robot 10 in Variation 8 are finished.

### Embodiment 2

### [Action of Robot]

The operation of robot 10 according to Embodiment 2 will be described. In Embodiment 2, an example in which robot 10 makes a preparatory movement before getting-off from mobile body 50 will be described.

The preparatory movement is an action for enabling one or more persons and robots 10 to get on and get off mobile body 50 efficiently. Examples of the preparatory movement include moving beforehand in mobile body 50 to make it easy for robot 10 to get off mobile body 50, and once getting off and getting on mobile body 50 again at a floor previous to a scheduled getting-off floor (hereinafter, this movement is also referred to as “temporal getting-off/on”). For example, by moving beforehand in mobile body 50 to take a position from which robot 10 easily gets off mobile body 50 at the scheduled getting-off floor or by getting off and getting on mobile body 50 again at a floor just previous to the scheduled getting-off floor of robot 10 to take a position from which robot 10 easily gets off mobile body 50 at the scheduled getting-off floor, the time it takes to get on and off mobile body 50 is shortened as a whole.

Also in Embodiment 2, the preliminary action is performed before the preparatory movement is made. The preliminary action in Embodiment 2 is the same as in Embodiment 1. Thus, Embodiment 2 will describe focusing on the preparatory movement. It is assumed in Embodiment 2 that mobile body management server 5 knows in advance the destinations of one or more persons and robots 10 on mobile body 50 and that the getting on and off of the one or more persons and robots 10 are managed.

Examples of the preparatory movement of robot 10 are as follows.

The first example is the case where a plurality of persons or robots 10 are scheduled to get on mobile body 50 at a floor at which mobile body 50 stops next, and almost all of them get off mobile body 50 at a floor later than a floor at which robot 10 already on mobile body 50 gets off from mobile body 50. In this case, at least one of the preparatory movement in mobile body 50 and temporal getting-off/on for mobile body 50 is selected according to the relationship between the number of robots 10 and an unoccupied space in mobile body 50.

The second example is the case where passengers including one or more robots 10 are on mobile body 50 at a given floor, and many passenger to get on mobile body 50 at a stopping floor next to the given floor requires one or more robots 10 to get off and get on mobile body 50 again. In this case, “disposition for getting-off preparation” in which one or more persons and robots 10 that get off mobile body 50 later are moved to the back (opposite to doorway 59) in mobile body 50, and one or more persons and robots that get off mobile body 50 earlier are moved to a position beside doorway 59 is performed. The disposition for getting-off preparation may be executed by the earlier robot getting off and getting on mobile body 50 again at the next stopping floor, rather than being executed when earlier robot 10 gets on mobile body 50. According to the second example, there is no need to consider the order of getting on at the floor at which robot 10 gets on mobile body 50. Thus, it is possible to shorten the time it takes to get on and get off mobile body 50.

The third example is the case where robot 10 makes the preparatory movement in mobile body 50 before mobile body 50 arrives the scheduled getting-off floor. In this case, robot 10 moves close to doorway 59 or changes its orientation. For example, robot 10 may change its orientation from a side-facing orientation to a front-facing orientation with respect to doorway 59. This preparatory movement is executed in the case where there is an unoccupied space in mobile body 50 and in the case where the floor occupancy proportion is low. The floor occupancy proportion is derived by calculation based on the floor area of mobile body 50 as a denominator and the total floor area of the one or more persons and robots 10 in mobile body 50 as a numerator. For example, in the case of a small floor occupancy proportion (e.g., less than or equal to 60%), robot 10 does not make the preparatory movement because robot 10 is less likely to interfere with a person to get off mobile body 50, and in the case of a large floor occupancy proportion (e.g., greater than 60% and less than or equal to 80%), robot 10 makes the preparatory movement to get off mobile body 50 efficiently. In the case of a too large floor occupancy proportion (e.g., greater than 80%), robot 10 may consider temporal getting-off/on rather than the preparatory movement in mobile body 50. According to the third example, it is possible to make an getting-off time shorter than when robot 10 changes its orientation after the arrival.

The fourth example is the case where robot 10 makes the preparatory movement in mobile body 50 at a stopping floor just previous to the scheduled getting-off floor. For example, at the just previous stopping floor, robot 10 changes its orientation or its arrangement. Robot 10 also changes its orientation to a front-facing orientation with respect to doorway 59 so that robot 10 can travel straight to doorway 59 or changes its orientation such that a plurality of robots 10 can travel in a single file. In this case, at least one of the preparatory movement in mobile body 50 and temporal getting-off/on for mobile body 50 is selected according to the relationship between the number of robots 10 and an unoccupied space in mobile body 50.

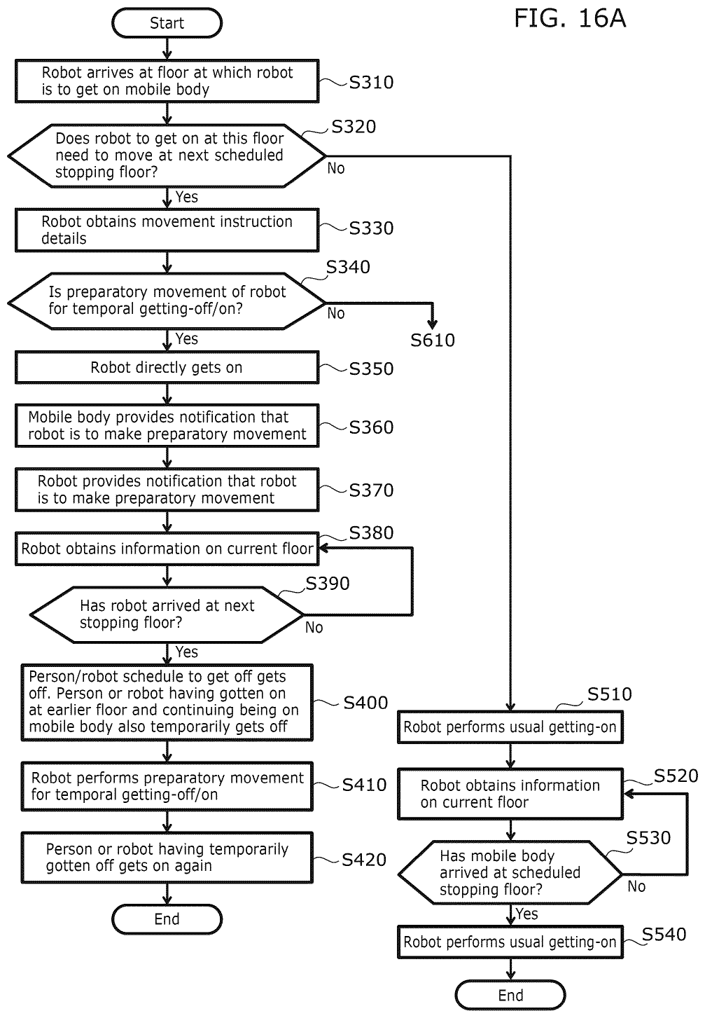

FIG. 15 is a flowchart illustrating an action of robot 10 according to Embodiment 2. With reference to FIG. 15, the third and fourth examples mentioned above will be described.

First, robot 10 obtains information on the current floor of mobile body 50 (step S110). For example, robot 10 obtains information on the current floor of mobile body 50 by detecting display on position indicator 57d with detector 13 or based on the position information on mobile body 50 sent from mobile body 50.

Robot 10 determines whether a floor at which mobile body 50 stops next is a scheduled stopping floor second previous to the scheduled getting-off floor of robot 10 (step S120). The scheduled stopping floor second previous to the scheduled getting-off floor is derived based on information on the scheduled getting-off floor stored in storage 16 and information on the scheduled stopping floor sent from mobile body 50.

When determining that the floor at which mobile body 50 stops next is not the scheduled stopping floor second previous to the scheduled getting-off floor (No in S120), the operation returns to the previous step, where robot 10 performs the process of step S110.

When determining that the floor at which mobile body 50 stops next is the scheduled stopping floor second previous to the scheduled getting-off floor (Yes in S120), robot 10 determines whether making the preparatory movement at a scheduled stopping floor just previous to the scheduled getting-off floor of robot 10 shortens a total getting-on/off time (step S130). The total getting-on/off time is the total time of the time it takes to get on and get off mobile body 50 at the floor just previous to the scheduled getting-off floor and the time it takes to get off mobile body 50 at the scheduled getting-off floor.

When determining that the total getting-on/off time is not shortened (No in S130), robot 10 executes the process of step S170 described later.

When determining that the total getting-on/off time is shortened (Yes in S130), robot 10 prepares the preparatory movement (step S140). The preparation for the preparatory movement is the preparation for the preparatory movement in mobile body 50. Mobile body 50 provides the notification that the preparatory movement is to be made at the next scheduled stopping floor. The notification of the preparatory movement is provided from information provider 57.

After mobile body 50 provides the notification, robot 10 provides the notification that robot 10 is to make the preparatory movement (step S150) and makes the preparatory movement (step S160). The preparatory movement in step S160 is, for example, the preparatory movement in the fourth example mentioned above.

Subsequently, robot 10 obtains information on the current floor of mobile body 50 (step S170).

Robot 10 next determines whether the current floor is the scheduled stopping floor just previous to the scheduled getting-off floor (step S180). The scheduled stopping floor just previous to the scheduled getting-off floor is derived based on information on the scheduled getting-off floor stored in storage 16 and information on the scheduled stopping floor sent from mobile body 50.

When determining that the floor at which mobile body 50 stops next is not the scheduled stopping floor just previous to the scheduled getting-off floor (No in S180), the operation returns to the previous step, where robot 10 performs the process of step S170.

When determining that the floor at which mobile body 50 stops next is the scheduled stopping floor just previous to the scheduled getting-off floor (Yes in S180), robot 10 determines whether making the preparatory movement before mobile body 50 arrives at the scheduled getting-off floor can shorten the getting-off time (step S190).

When determining that making the preparatory movement before mobile body 50 arrives at the scheduled getting-off floor does not shorten the getting-off time (No in S190), robot 10 performs the process of step S230.

When determining that making the preparatory movement before mobile body 50 arrives at the scheduled getting-off floor can shorten the getting-off time (Yes in S190), robot 10 determines the details of the preparatory movement of robot 10 (step S200). The details of the preparatory movement are information on the detailed movement of robot 10 such as a movement of robot 10 toward doorway 59 or a change of the orientation of robot 10.

Mobile body 50 provides the notification that the preparatory movement is to be made before the next scheduled stopping floor. The notification of the preparatory movement is provided from information provider 57. Note that, in this case, the preparatory movement is made in favor of one or more persons. It is desirable that mobile body 50 notify one or more persons in the vicinity of robot 10 that robot 10 is to perform the preliminary action and then move. In this case, it is also desirable that mobile body 50 notifies one or more persons in the vicinity of robot 10 of a specific movement. For example, mobile body 50 may provide the notification that, for example, robot 10 is to change its orientation such that the longitudinal direction of robot 10 points to doorway 59 so as to allow a person whose scheduled getting-off floor is later than that of robot 10 to smoothly move to a position farther back than robot 10.

After mobile body 50 provides the notification, robot 10 provides the notification that robot 10 is to make the preparatory movement (step S210) and makes the preparatory movement (step S220). The preparatory movement in step S220 is, for example, the preparatory movement in the third example mentioned above.

Examples of this preparatory movement include robot 10 waiting beside doorway 59 before getting-off and robot 10 changing its orientation to the front-facing orientation in the case where the orientation of robot 10 is a side-facing orientation with respect to doorway 59. In the case of a low occupancy rate in mobile body 50, there is room for robot 10 to move in mobile body 50. Thus, moving beforehand to a position and an orientation from which robot 10 easily gets off mobile body 50 shortens the getting-off time. For making the preparatory movement, it is necessary to form a gap ahead of robot 10 in the moving direction that is not too narrow but moderate. It is desirable in mobile body 50 to form such a gap that robot 10 does not come in contact with a person (e.g., 5 cm).

After finishing the preparatory movement, robot 10 obtains information on the current floor of mobile body 50 (step S230).

Next, robot 10 determines whether mobile body 50 has arrived at the scheduled getting-off floor (step S240). For example, robot 10 obtains the information on whether mobile body 50 has arrived at the scheduled getting-off floor, by detecting the display on position indicator 57d with detector 13 or based on the position information on mobile body 50 sent from mobile body 50.

When determining that mobile body 50 has not arrived at the scheduled getting-off floor (No in S240), the operation returns to step S230, and robot 10 performs the process of step S230.

When determining that mobile body 50 has arrived at the scheduled getting-off floor (Yes in S240), robot 10 gets off mobile body 50 (step S250). The getting-off action is the same as in Embodiment 1.

Note that, in Embodiment 2, the preparatory movement and the getting-off action are both performed, and thus one or more persons on mobile body 50 may fail to notice whether the action of robot 10 is the preparatory movement or the getting-off action. Thus, robot 10 may perform the actions described below.

For example, robot 10 may send a notification indicating signal to mobile body 50 to cause mobile body 50 to provide the notification that an action to be performed by robot 10 is the preparatory movement or that the action is the getting-off action.

Specifically, in the case where a plurality of robots 10 are to make the preparatory movement in mobile body 50, robot 10 may cause mobile body 50 to announce, “These robots will now move in the mobile body but will not get off at the next stopping floor.” In the case where one robot 10 is to make the preparatory movement in mobile body 50, robot 10 may cause mobile body 50 to announce, “The robot will move in the mobile body but will not get off at the next stopping floor.” In the case where a plurality of robots 10 are to perform temporal getting-off/on, robot 10 may cause mobile body 50 to announce, “These robots will get off and get on the mobile body again at the next stopping floor. At the next stopping floor, the robots will temporarily get off and get on the mobile body again.”

In the case where a plurality of robots 10 present in mobile body 50 are to get off mobile body 50, robot 10 may cause mobile body 50 to announce, “These robots will get off the mobile body at the next stopping floor.” In the case where one robot 10 is to get off mobile body 50, robot 10 may cause mobile body 50 to announce, “One robot will get off the mobile body at the next stopping floor.”

### Variation 1 in Embodiment 2

The operation of robot 10 according to Variation 1 of Embodiment 2 will be described.

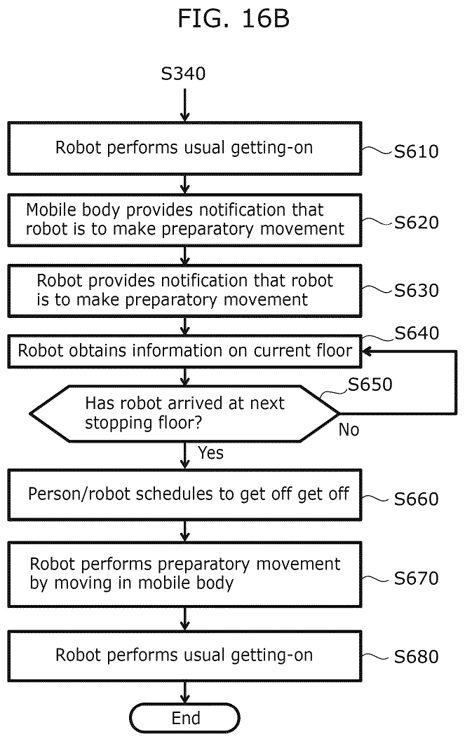

FIG. 16A is a flowchart illustrating an action of robot 10 according to Variation 1 of Embodiment 2. FIG. 16B is a flowchart illustrating an action of robot 10 according to Variation 1 of Embodiment 2, continued from FIG. 16A. With reference to FIG. 16A and FIG. 16B, the first and second examples mentioned above will be described. Note that FIG. 16A and FIG. 16B illustrate the operation of not only robot 10 but also management system 1 as a whole.

First, robot 10 arrives at a floor at which robot 10 is to get on mobile body 50 (step S310).

Next, it is determined whether robot 10 that is to get on mobile body 50 at this floor needs to move at the next scheduled stopping floor (step S320).

When it is determined that the movement is not needed (No in S320), the operation proceeds to step S510, and a usual getting-on is performed (step S510). After performing the usual getting-on, robot 10 obtains information on the current floor (step S520), and it is determined whether robot 10 has arrived at the next scheduled stopping floor (step S530). In the case where robot 10 has not arrived at the next scheduled stopping floor (No in S530), the operation returns to step S520. In the case where robot 10 has arrived at the next scheduled stopping floor (Yes in S530), a usual getting-on is continuously performed (step S540).

In contrast, when it is determined that the movement is needed (Yes in S320), robot 10 obtains movement instruction details (step S330). The movement instruction details include information indicating, for example, whether the preparatory movement of robot 10 to be made is a movement for temporal getting-off/on or a movement in mobile body 50.

Next, it is determined whether the preparatory movement of robot 10 is temporal getting-off/on (step S340). When the preparatory movement of robot 10 is not temporal getting-off/on but a movement in mobile body 50 (No in S340), the operation proceeds to step S610 illustrated in FIG. 16B. Step S610 will be described later.

When the preparatory movement of robot 10 is temporal getting-off/on (Yes in S340), robot 10 once directly gets on mobile body 50 (step S350). Note that in the case where one or more persons get on mobile body 50 at this floor, robot 10 gets on mobile body 50 in such a manner as not to come in contact with the one or more persons.

Mobile body 50 provides the notification that the preparatory movement is to be made before the next scheduled stopping floor (step S360). For example, in the case where many persons or robots get on mobile body 50 at the next scheduled stopping floor, which require one or more robots already on mobile body 50 to perform temporal getting-off/on, mobile body 50 desirably provide notification that many persons or robots are to get on mobile body 50 at the next stopping floor, and that the one or more robots already on mobile body 50 are to get off and get on again mobile body 50. The notification of the preparatory movement is provided from information provider 57. In this case, the preparatory movement is made in favor of one or more persons in mobile body 50. It is desirable that mobile body 50 notifies one or more persons in the vicinity of robot 10 that robot 10 is to perform the preliminary action and then move. It is also desirable that mobile body 50 notifies one or more persons in the vicinity of robot 10 of a specific movement. For example, mobile body 50 may provide the notification that one or more robots 10 already on mobile body 50 are to once get off mobile body 50, then one or more persons whose scheduled getting-off floors are later than that of one or more robots 10 are to get on mobile body 50 earlier than one or more robots 10, next one or more robot 10 having once gotten off mobile body 50 are to get on mobile body 50, and furthermore one or more persons whose scheduled getting-off floors are earlier than that of one or more robots 10 are to get on mobile body 50.

After mobile body 50 provides the notification, robot 10 provides the notification that robot 10 is to make the preparatory movement (step S370).

Next, robot 10 obtains information on the current floor of mobile body 50 (step S380). For example, robot 10 obtains the information on the current floor of mobile body 50 by detecting the display on position indicator 57d with detector 13 or based on the position information on mobile body 50 sent from mobile body 50.

Next, it is determined whether robot 10 has arrived at the next stopping floor (step S390). When it is determined that robot 10 has not arrived at the next stopping floor (No in S390), the operation returns to step S380.

When it is determined that robot 10 has arrived at the next stopping floor (Yes in S390), one or more persons or robots 10 scheduled to get off mobile body 50 get off mobile body 50, and a person or robot 10 that has gotten on at an earlier floor and continues being on mobile body 50 also temporarily gets off mobile body 50 (step S400).

Next, robot 10 performs the preparatory movement for temporal getting-off/on according to the movement instruction details (step S410). By the temporal getting-off/on, the person or robot 10 that has temporarily gotten off mobile body 50 gets on mobile body 50 again (step S420). In addition, in the case where there is a person or another robot 10 that is to get on mobile body 50 at this floor, the person or the other robot 10 gets on mobile body 50 at the same time. At this time, re-getting-on for the disposition for getting-off preparation and usual getting-on are executed. Accordingly, the preparatory movement by robot 10 for the temporal getting-off/on completes.

In contrast, in step S340, when the preparatory movement of robot 10 is not for temporal getting-off/on (No in S340), that is, when the preparatory movement is the preparatory movement in mobile body 50, a usual getting-on of robot 10 is performed (step S610 in FIG. 16B).

After the usual getting-on is performed, mobile body 50 provides the notification that the preparatory movement in mobile body 50 is to be made before the next scheduled stopping floor (step S620).

After mobile body 50 provides the notification, robot 10 provides the notification that robot 10 is to make the preparatory movement (step S630).

Next, robot 10 obtains information on the current floor of mobile body 50 (step S640).

It is determined whether robot 10 has arrived at the next stopping floor (step S650). When it is determined that robot 10 has not arrived at the next stopping floor (No in S650), the operation returns to step S640.

When it is determined that robot 10 has arrived at the next stopping floor (Yes in S650), one or more persons or robots 10 scheduled to get off mobile body 50 get off mobile body 50 (step S660).

Next, robot 10 performs the preparatory movement by moving in mobile body 50 according to the movement instruction details (step S670). Robot 10 then subsequently performs a usual getting-on (step S680). Accordingly, the preparatory movement by moving in mobile body 50 is finished.

### Embodiment 3

### [Operation of Management System]

The operation of management system 1 including robot 10 according to Embodiment 3 will be described. In Embodiment 3, an operation in an emergency such as an earthquake or a fire will be described.

When detecting an earthquake or a fire, management system 1 urges all persons to get off mobile body 50 with an announcement from mobile body 50 or the like. For example, in the case where robot management server 2 and mobile body management server 5 cooperate with each other, management system 1 derives a safe evacuation route and guides the persons. In this case, management system 1 guides the persons avoiding an obstacle, a flame, and a smoke-filled spot.

Management system 1 evacuate the persons on a priority basis. For example, when robot 10 gets off mobile body 50, robot 10 moves in such a manner as not to interfere with the route of the person. Note that in the case where robot 10 guides the persons, the notification of information on evacuation guidance may be provided in mobile body 50. In this case, the notification of which of robots 10 is to perform the evacuation guidance may be provided using sound or light from robot 10 or mobile body 50. The robot may perform the evacuation guidance while moving together with the persons. Alternatively, robot 10 may notify the persons of the information on the evacuation guidance without getting off mobile body 50.

When an earthquake or a fire is detected, mobile body 50 makes an emergency stop at the nearest floor. Note that in the case where the nearest floor is heavily damaged or a fire has occurred on the nearest floor, mobile body 50 makes the emergency stop at a safe floor.

After mobile body 50 stops at the nearest floor or the safe floor in an emergency, robot 10 let the persons get off mobile body 50 on a priority basis. In the case where robot 10 will not hinder the flow of the evacuation of the persons, robot 10 may be stationary. In the case where robot 10 will hinder the flow of the evacuation of the persons, robot 10 may move in mobile body 50 in such a manner as not to hinder the flow or may get off mobile body 50 with the flow. In this case, before moving, robot 10 may perform the preliminary action to notify beforehand the surroundings that robot 10 is to move. Note that whether robot 10 stays there, only moves in mobile body 50, or gets off mobile body 50 is determined based on the floor occupancy proportion in mobile body 50, and the position and the orientation of robot 10 in mobile body 50.

Note that the preparatory movement of robot 10 in mobile body 50 is performed in the case where the preparatory movement advances the getting-off of one or more persons and robots 10. For example, in the case where mobile body 50 is crowded, robot 10 may change its orientation in mobile body 50, may shift to an end of mobile body 50, or may move to the back after mobile body 50 arrives at an emergency stop floor and before the passengers get off mobile body 50. Robot 10 need not get off mobile body 50 in the case where not getting-off advances the getting-off of one or more persons. In the case where there is robot 10 that will hinder the getting-off of a person, robot 10 may be first caused to get off mobile body 50 and remaining one or more robots 10 may be caused to get off mobile body 50 after the getting-off of the persons is completed.

### [Action of Robot]

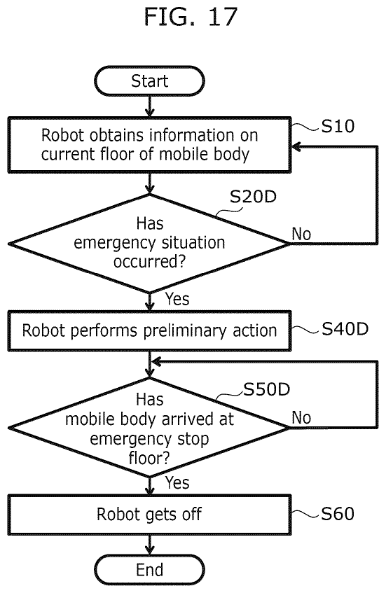

FIG. 17 is a flowchart illustrating an action of robot 10 according to Embodiment 3. In this figure, an example in which the preliminary action is performed before robot 10 gets off mobile body 50 in an emergency situation will be described.

First, robot 10 obtains information on the current floor of mobile body 50 (step S10). For example, robot 10 obtains the information on the current floor of mobile body 50 by detecting the display on position indicator 57d with detector 13 or based on the position information on mobile body 50 sent from mobile body 50.

Next, robot 10 determines whether an emergency situation such as an earthquake or a fire has occurred (step S20D). For example, the occurrence of the emergency situation is reported to robot 10 from mobile body management server 5 via robot management server 2 or reported to robot 10 from mobile body management server 5 via mobile body 50. Note that robot 10 may detect the occurrence of the emergency situation with camera 13a of detector 13.

In the case where the emergency situation does not occur (No in S20D), robot 10 performs the operation described in Embodiment 1.

In the case where the emergency situation has occurred (Yes in S20D), robot 10 performs the preliminary action based on information on a location where robot 10 is to get off mobile body 50 (step S40D). In this case, the information on the location where robot 10 is to get off mobile body 50 is information on the emergency stop floor of mobile body 50. For example, the information on the emergency stop floor of mobile body 50 is reported to robot 10 from mobile body management server 5 via robot management server 2 or reported to robot 10 from mobile body management server 5 via mobile body 50.

When finishing the preliminary action, robot 10 determines whether mobile body 50 has arrived at the emergency stop floor (step S50D). For example, robot 10 obtains the information on whether mobile body 50 has arrived at the emergency stop floor, by detecting the display on position indicator 57d with detector 13 or based on the position information on mobile body 50 sent from mobile body 50.

When determining that mobile body 50 has not arrived at the emergency stop floor (No in S50D), robot 10 performs the process of step S50D again.

When determining that mobile body 50 has arrived at the emergency stop floor (Yes in S50D), robot 10 gets off mobile body 50 (step S60). For example, robot 10 performs the getting-off action, which is the main action, by driving mobilizing mechanism 17a. Through the steps illustrated in FIG. 17, the preliminary action and the getting-off action of robot 10 are finished.

### (Other Examples of Management System)

Other examples of the management system will be described.

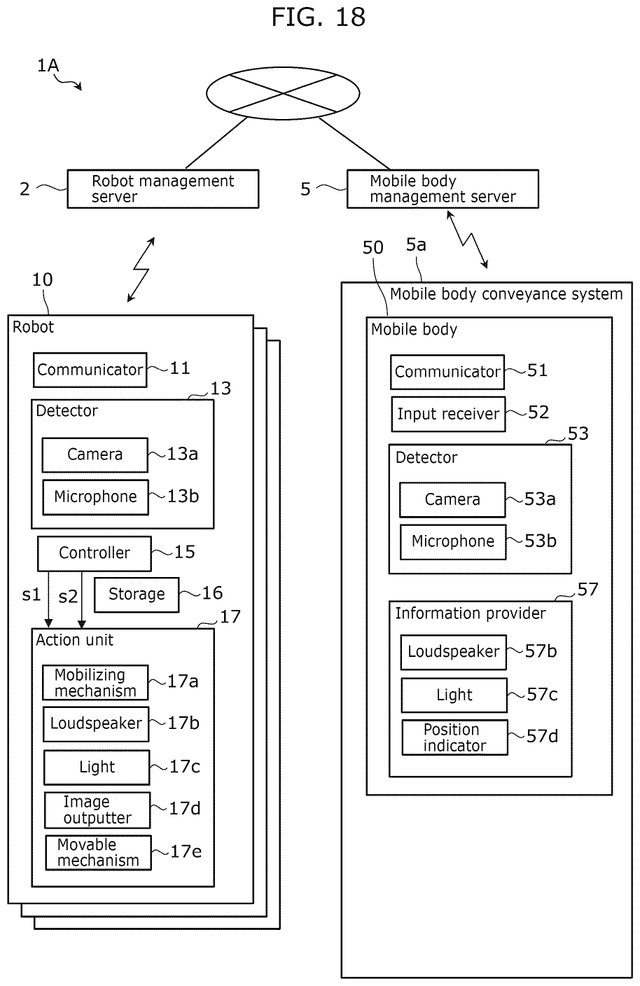

FIG. 18 is a diagram illustrating another example of the management system. With reference to FIG. 18, an example in which robots 10 and mobile body 50 cannot directly communicate with each other will be described.

As illustrated in FIG. 18, management system 1A in this example includes a plurality of robots 10, robot management server 2, mobile body 50, mobile body conveyance system 5a, and mobile body management server 5.

Robots 10 and robot management server 2 are capable of communicating with each other in a wireless manner. Mobile body 50 and mobile body conveyance system 5a are capable of communicating with each other in a wired or wireless manner. Mobile body conveyance system 5a and mobile body management server 5 are capable of communicating with each other in a wired or wireless manner. Robot management server 2 and mobile body management server 5 may be capable of communicating with each other over a communication network. In management system 1A, robots 10 and mobile body 50 cannot communicate with each other.

In management system 1A, all the information exchanged between robots 10 and mobile body 50 in Embodiment 1 is exchanged via robot management server 2 and mobile body management server 5. Even in management system 1A, it is possible to notify beforehand that robot 10 is to get off mobile body 50 as in Embodiment 1.

Still another example of the management system will be described.

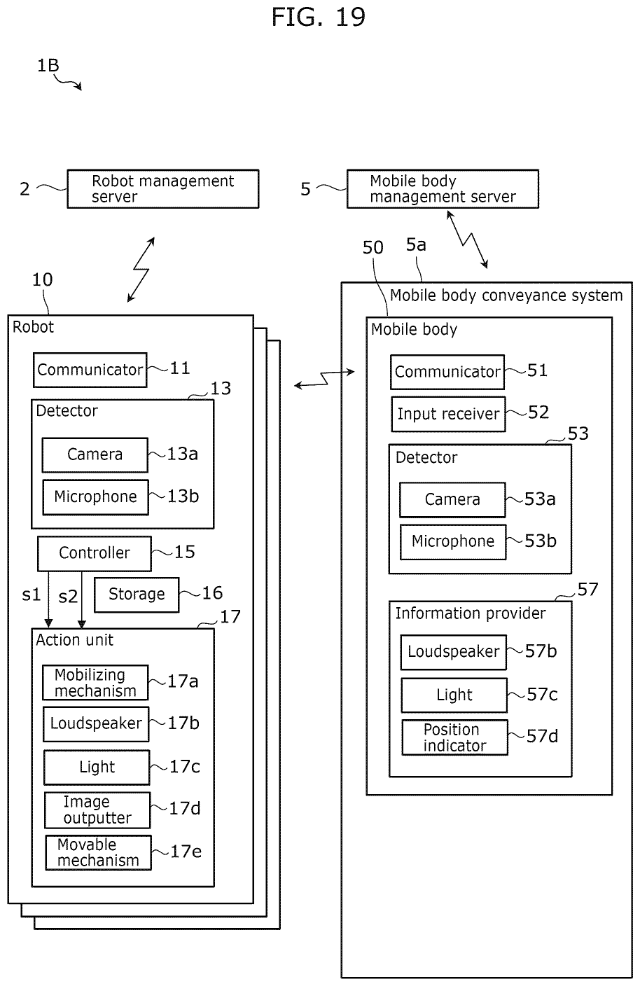

FIG. 19 is a diagram illustrating the other example of the management system. With reference to FIG. 19, an example in which no communication is established between robot management server 2 and mobile body management server 5, while robots 10 and mobile body 50 can directly communicate with each other will be described.

As illustrated as management system 1B in FIG. 19, in the case where robots 10 and mobile body 50 can directly communicate with each other, all the information exchanged via robot management server 2 and mobile body management server 5 in Embodiment 1 is exchanged through the communication between robots 10 and mobile body 50. Even in management system 1B, it is possible to notify beforehand that robot 10 is to get off mobile body 50 as in Embodiment 1.

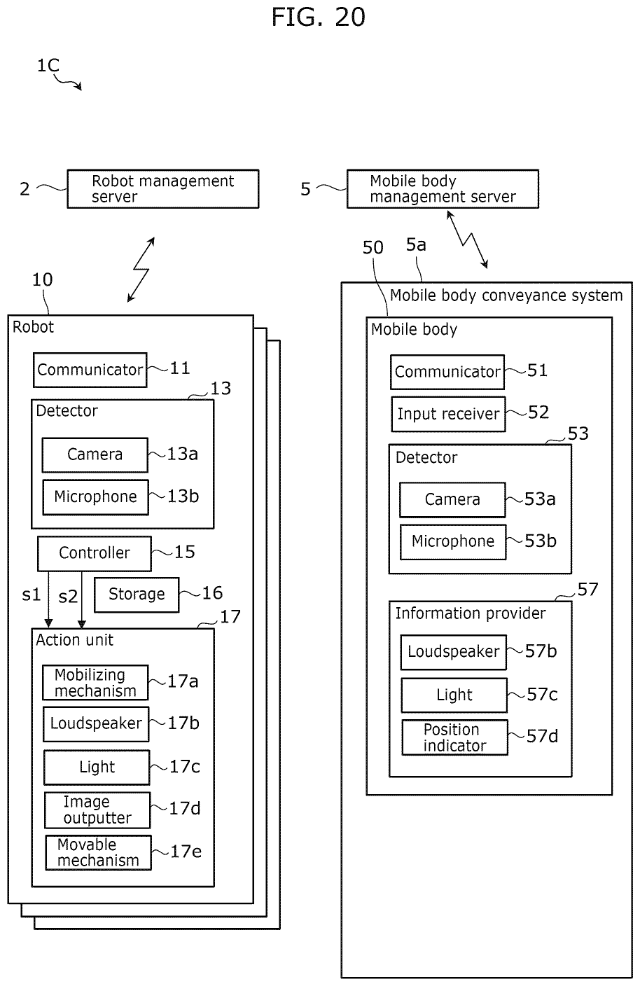

FIG. 20 is a diagram illustrating another example of the management system. With reference to FIG. 20, an example in which no communication is established between robot management server 2 and mobile body management server 5, and robots 10 and mobile body 50 cannot directly communicate with each other will be described.

As illustrated as management system 1C in FIG. 20, in the case where robots 10 and mobile body 50 cannot directly communicate with each other, the information exchanged via robot management server 2 and mobile body management server 5 in Embodiment 1 and the information exchanged between robots 10 and mobile body 50 are not available for robots 10 and mobile body 50.

In this case, mobile body 50 obtains information on robot 10 with camera 53a and microphone 53b and outputs the information on robot 10 by means of sound from loudspeaker 57b and visible light from light 57c. Robot 10 obtains information on the inside of mobile body 50 with camera 13a and microphone 13b and outputs information on robot 10 by means of sound from loudspeaker 17b, visible light from light 17c, and display on image outputter 17d. For example, robot 10 can capture an image of the display of a floor number displayed on position indicator 57d of mobile body 50 with camera 13a and can obtain the current position of mobile body 50 from the image. Robot 10 can also obtain sound about the scheduled stopping floor emitted from mobile body 50 with microphone 13b and can obtain information on the scheduled stopping floor of mobile body 50.

Even in management system 1C, it is possible to notify beforehand that robot 10 is to get off mobile body 50 by obtaining and outputting the information as described above.

### Other Examples

Supplemental descriptions will be given of other examples relating to Embodiments 1 to 3.

First, some supplemental descriptions will be given of examples in which robot 10 moves in mobile body 50.

For example, in the case where one or more persons get on a stopped elevator and get off at a floor later than that of robot 10, robot 10 performs an action of moving toward the doorway side of the elevator to leave an unoccupied space on the back side of the elevator. In this case, mobile body management server 5 may grasp the number of persons and the number of robots 10 getting on the elevator and the getting-off floors of the one or more persons and robots 10 and may transmit the numbers and the getting-off floors to robots 10 via robot management server 2.

For example, in the case where a person puts down a piece of baggage held with the person's hand or a child held by the person onto the floor of the elevator, the occupied area of the floor increases. Thus, it is necessary to move robot 10 to keep a gap that allows a person to move or a gap between person. In this case, mobile body management server 5 may grasp the situation of inside of the cage based on a camera image viewed from the ceiling side of the elevator and may transmit the situation to robot 10 via robot management server 2.

For example, a child's moving to a place of their parents, a person's sitting in a train or a bus standing up and moving, a person's moving to a space made by another person's moving and sitting down at another space, or the like may occur at a timing that does not necessarily match the arrival of the elevator at a getting-on/off floor or a stopping place. For example, the movement of a member of a family can be detected based on the attribute of a person, information on an accompanying person, and a camera image. Movements of other types can be detected by detecting the movement of a space or a person based on a camera image. In this case, mobile body management server 5 may grasp the situation of the movement based on information on the detection from a camera image and may transmit the situation of the movement to robot 10 via robot management server 2.

For example, in the case where robot 10 performs the preliminary action while a nearby person or the like is moving, it is difficult for the person or the like to perceive the preliminary action by robot 10. In this case, robot 10 may perform the preliminary action with loudspeaker 17b, light 17c, and image outputter 17d. Note that robot 10 may make a movement concurrently with the preliminary action with loudspeaker 17b, light 17c, and image outputter 17d.

Next, a supplemental description will be given of an example in which the preliminary action without a three-dimensional movement.

For example, a person in the vicinity of robot 10 feels uneasy in the case where robot 10 is moving toward the person where there is no gap to avoid robot 10. This is specifically the case where a person (you) is present in a narrow space between robot 10 and the surrounding wall (the inner wall surface or the doorway) of the elevator, and further, another robot 10 or person is present between the person (you) and the surrounding wall in a lateral direction. Such a person may feel uneasy at even the movement of robot 10 in place without a lateral movement or even a slow, slight reciprocating motion in a lateral direction. In this case, action unit 17 that performs the preliminary action may perform an action with loudspeaker 17b, light 17c, and image outputter 17d, which is an action without a three-dimensional movement.

Next, a supplemental description will be given of an example in which robot 10 performs a moving action, operates a given mechanism of robot 10 without moving, or performs an action without a three-dimensional movement when performing the preliminary action.

For example, a person in the vicinity of robot 10 feels uneasy at the operation of action unit 17 relating to the movement of robot 10 in the case where robot 10 is moving toward the person. For example, a person present in front of or behind robot 10 tends to feel uneasy in the case where there is no object or no other person present between the person and robot 10. Furthermore, a person more tends to feel uneasy when the person is located on the doorway side of the elevator. In such cases, even if the movement of robot 10 is a slight reciprocating motion, a person feels uneasy when robot 10 moves towards the person. Thus, in the case of operating action unit 17 relating to the movement of robot 10, it is desirable to operate action unit 17 in a direction perpendicular to a direction in which the person is present, operate movable mechanism 17e that is action unit 17 not relating to the movement of robot 10, or operate loudspeaker 17b, light 17c, image outputter 17d, which do not involve a three-dimensional movement.

Next, a supplemental description will be given of an example in which the preliminary action is explained.

For example, even when a light, which is an immobile component of robot 10, is turned on while robot 10 is stopped, a person who is hypersensitive to a change in environment may feel uneasy with an anxiety that robot 10 will move. The person feels uneasy because of having no idea about the meaning of the light of robot 10 being turned on, for example, why the light has been turned on, how robot 10 will move, or the like. Although robot 10 in the present embodiment is configured to perform the preliminary action before moving, there can be a case where a person in the vicinity of robot 10 does not understand the meaning of the preliminary action. Thus, in order to eliminate the uneasiness, it is desirable to explain the preliminary action by robot 10 or explain an action to be performed by robot 10 before or concurrently with the preliminary action so as to make the person in the vicinity of robot 10 understand the preliminary action.

For example, as a preparatory explanation, the notification of information indicating “The robot will get off at the next floor,” “The robot will perform a preliminary action,” “The robot will perform the same preliminary action it just did before moving when arriving at the next floor,” or the like may be provided by means of a voice guidance in the cage of the elevator or a voice guidance from loudspeaker 17b of robot 10. It is considered that when robot 10 actually getting-off the elevator performs the preliminary action after the notification, a person in a vicinity of robot 10 tends not to feel uneasy at robot 10 performing the action with mobilizing mechanism 17a.

In addition, for example, the notification of information indicating “This is a preliminary action. The robot will get off,” “This is a preliminary action. The robot will move to a position for getting off,” or the like may be provided by means of a voice guidance in the cage of the elevator or a voice guidance from loudspeaker 17b of robot 10. Before or during the preliminary action, robot 10 may display the information on a display device being image outputter 17d. Depending on the position of the display device, some person cannot see the information. Thus, in the case where the notification is provided using characters, the notification is desirably provided at a high position in the cage of the elevator.

Next, a supplemental description will be given of an example of the preliminary action performed before robot 10 changes its orientation and position.

Only the preliminary action cannot notify one or more persons in the vicinity of robot 10 when and how robot 10 changes its orientation and position in the main action.

Thus, in the case where one or more persons in the vicinity of robot 10 have been notified that the preliminary action is performed for providing the notification before robot 10 moves, the preliminary action may be performed with loudspeaker 17b or image outputter 17d as well as another action unit, and the notification of information indicating “I will turn 90° to the right,” “I will turn my head toward the door,” “I will move 50 cm toward the door,” or the like by means of a voice guidance or a display on the display device. Note that the explanations of the actions by robot 10 are not needed in the case where the explanations are to be provided by means of a voice guidance or a display on the display device in the cage of the elevator concurrently with the preliminary action by robot 10.

In contrast, in the case where one or more persons in the vicinity of robot 10 have not been notified that the preliminary action is performed for providing the notification before robot 10 moves, robot 10 may perform the preliminary action while explaining that “The robot will perform a preliminary action before moving” by means of a voice guidance or a display on the display device by robot 10 itself or in the cage of the elevator and subsequently provide the notification of information indicating “I (the robot) will turn 90° to the right” or the like by means of a voice guidance or a display on the display device as above.

In the case where robot 10 performs the preliminary action with a movement, the preliminary action is influenced by not only the distance to a person present in the moving direction of robot 10 but also an unoccupied space around the person. For example, a person cannot move where there is no unoccupied space around the person.

Thus, in the case of a short distance between robot 10 and the person, robot 10 may perform the preliminary action without a three-dimensional movement and may notify that robot 10 is to move after the cage of the elevator arrives at the getting-on/off floor and robot 10 and the person in the cage becomes able to move. In contrast, in the case of a long distance between robot 10 and the person, robot 10 may perform the preliminary action without a movement toward the person and may notify that robot 10 is to move after the cage of the elevator arrives at the getting-on/off floor and robot 10 and the person in the cage becomes able to move.

On the other hand, in the case where there is an unoccupied space around a person, robot 10 does not come in contact with the person when moving, and the person can move to the unoccupied space. Thus, robot 10 can perform the preliminary action with a three-dimensional movement. However, robot 10 may make a small movement in place because a large movement in a closed space such as the cage scares the person as with an actual movement.

The preliminary action by robot 10 without a three-dimensional movement is useful in all cases. However, the sound volume of loudspeaker 17b and the luminance of light 17c needs to be adjusted to such proper degrees that a person perceives the sound and light without founding the sound and light annoying and dazzling. In the case where the preliminary action is performed with sound, it is desirable to set the sound volume of loudspeaker 17b to a level at which all persons in the elevator can hear the sound moderately.

For example, robot 10 getting-off the elevator moves toward the doorway. Thus, robot 10 may notify its surroundings of the movement direction and an estimated movement time of robot 10.

For example, in the case where robot 10 notifies its surroundings of its position in the cage that is determined according to its getting-off floor, and the disposition for getting-off preparation in the cage is executed based on the notification, a person present closer to the doorway side than robot 10 is to get off the elevator at the same floor as or a floor earlier than that of robot 10. In this case, a person present in the moving direction of robot 10 is less likely to feel deeply uneasy.

In contrast, in the case where a person present in the moving direction of robot 10 is to get off at a floor later than that of robot 10, the person may be frightened when robot 10 moves. Thus, robot 10 moves in the elevator or gets off the elevator once to get off and get on the elevator again. At this time, robot 10 performs the preliminary action before moving to notify its surroundings that robot 10 is to move and notifies the person present in the moving direction of robot 10 of a scheduled action by means of a voice guidance or a display on the display device immediately before robot 10 moves. Accordingly, the person present in the moving direction of robot 10 can learn a future movement of robot 10 even in the case where robot 10 gets off earlier than the person. As a result, the person can be emotionally prepared, thus feeling at ease.

For example, in the case where there is no unoccupied space around a person present in the moving direction of robot 10, robot 10 may move toward the doorway to notify the person that robot 10 is to get off, after the elevator arrives at the getting-off floor of robot 10. In the case where there is an enough unoccupied space around a person present in the moving direction of robot 10, robot 10 may notify the person of a scheduled action, for example, “I will move approaching the doorway,” “I will turn may head toward the doorway,” or “My hip is facing the doorway, but I will approach the doorway in this state, and my hip will get off first.”

Robot 10 may provide guidance on the scheduled action using loudspeaker 57b or a display device in the cage of the elevator. With the guidance on the scheduled action, the scheduled action of robot 10 is transmitted to all persons in the cage. Accordingly, for example, in the case where a person present in the moving direction of robot 10 does not get off but continues being on the elevator, it is possible to cause another person to clear the way for robot 10 when robot 10 moves.

Next, a supplemental description will be given of an example in which the notification is provided beforehand in the case where a child or a physically impaired person is present in mobile body 50.

For example, in the case where there is a child in mobile body 50, robot 10 performs an action that stimulates the child's interest in robot 10 using mobilizing mechanism 17a and movable mechanism 17e. After checking that the child is looking at robot 10 with the camera or the like, robot 10 performs the preliminary action before starting moving. The action that stimulates the child's interest may be a sound from loudspeaker 17b, an animated cartoon on image outputter 17d, flashing of light 17c, or the like. Children are scared of a deep voice of an adult. Thus, robot 10 may output a voice “I will move,” “I will start,” or the like with a voice of a young person or a child.

For example, in the case where there is a physically impaired person whose impairment details are unknown in mobile body 50, an action for visually impaired persons and an action for hearing-impaired persons are performed at the same time. For a hearing-impaired person, a portable electronic authenticator (a device that responds the application of a radio wave or the like with an answer signal) that can output a short, simple character string or a video of silent mouthing, or sign language or can authenticate the impairment details in a contactless manner. For a white cane user, sense of hearing and sense of touch can be used. Thus, the preliminary action is performed with sound or vibration.

Robot 10 may recognize a visually impaired person by recognizing a white cane, a guide dog, a walking assistant and by using a portable electronic authenticator to recognize the combination of the white cane and the guide dog or the combination of the white cane and the walking assistant or the like. Robot 10 may recognize a hearing-impaired person using a hearing aid, a portable electronic authenticator, a sign language action, and the combination thereof.

Next, a supplemental description will be given of information on the impairment details of a physically impaired person.

For example, understanding the impairment details of the physically impaired person facilitates the assistance of the physically impaired person. When in need of assistance, a physically impaired person wants a nearby person to help the physically impaired person. However, when not in need of assistance, the physically impaired person wants a nearby person not to interfere with the physically impaired person. In addition, a physically impaired person does not want a nearby person to know their impairment details unless the physically impaired person needs assistance. Therefore, it suffices if robot 10 performs an action according to the necessity of the assistance.

In an elevator system in which the getting-on/off floors of robot 10 are preset, robot 10 registers information on the getting-on/off floors in mobile body management server 5 via robot management server 2. In the case of a person, the person uses an information terminal (e.g., a smartphone) to register information on their getting-on/off floors in mobile body management server 5. Then, stopping floors of the elevator and robot 10 and a person to get on the elevator are determined in such a manner as to minimize waiting times of robot 10 and the person.

In the case where a user of the elevator registers the user in the elevator system and also registers the impairment details of the user, mobile body management server 5 can provide robots 10, via robot management server 2, with information indicating that a physically impaired person is on the elevator and information indicating the impairment details of the physically impaired person.

Mobile body management server 5 can also identify the position of the physically impaired person in the cage of the elevator by checking a video from a camera monitoring the inside of the cage and checking a user ID at the time of getting-on. Mobile body management server 5 can also identify the position and the orientation of robot 10. Information on the positions and the orientations of the physically impaired person and robot 10 is sent from the elevator to mobile body management server 5 and further sent to robot 10 via robot management server 2. Accordingly, robot 10 can perform an action made for the physically impaired person.

Note that even in the case of setting the getting-on/off floors before a boarding floor rather than registering the getting-on/off floors beforehand, robot 10 can perform an action made for the physically impaired person by setting the presence or absence of visual impairment and the presence or absence of hearing impairment.

Next, a supplemental description will be given of an example of calculating a getting-on/off time of robot 10 for mobile body 50.

Pieces of information on the getting-on/off floors of robots 10 and persons, the waiting times of robots 10 and the persons after the elevator arrives at the getting-on floors, the number of robots 10 and persons waiting for getting on at each stopping floor, and the like are aggregated in mobile body management server 5 before robots 10 and the person get on the elevator. Based on these pieces of information, the stopping floors of the elevator, the numbers of robots 10 and the persons getting on at each stopping floor are determined.

The positions of robots 10 and the persons in the cage of the elevator, particularly the distances from robots 10 and the persons to the doorway are determined based on the getting-off floors of robots 10 and persons. For example, the positions are determined such that robot 10 and a person getting-off at a much later floor are located farther back in the cage and robot 10 and a person getting-off at a just next floor are located on the doorway side. In the case where robot 10 and a person are to get off at the same floor, the relationship between robot 10 and the person is determined such that the person is located on the doorway side. Regarding the relationship among robots 10, the positions of robots 10 are determined such that small robots are located on the doorway side so as to increase the number of robots 10 that can move at the same time.

The getting-on/off time will be estimated assuming that the size of the cage of the elevator is 4 m square, and the persons and robots 10 both move at 1.5 m/s. The getting-on/off time will be estimated for the case where one robot 10 gets on the cage, and the elevator arrives at a stopping floor just previous to a floor at which robot 10 is to get off. In getting on and off the elevator, robot 10 and a person start to get on the elevator after all robots 10 and persons to get off get off the elevator. In the getting on and off, it is assumed that the distance between persons is 1 m, and the distance between persons with robot 10 sandwiched therebetween is 2.5 m. It is also assumed that the distance between robots 10 with robot 10 sandwiched therebetween and the distance between robot 10 and a person are also 2.5 m, which are however not estimated here. It is also assumed that the depth of a space in front of the elevator (a waiting space) when the cage of the elevator stops at a stopping floor and the door opens is 4 m.

In the case of getting on and off in the state where there is no obstacle in front of the door of the elevator at a stopping floor, a getting-on time and a getting-off time are calculated to include a time it takes to move this 4 m. It is assumed that, in the case where robot 10 or a person in the cage interferes in getting on and off the elevator, robot 10 and the person moves one by one, and in the case where robot 10 or the person does not interfere, two robots 10 or three persons can move at a time.

Here, Calculation example 1 of temporal getting-off/on will be described.

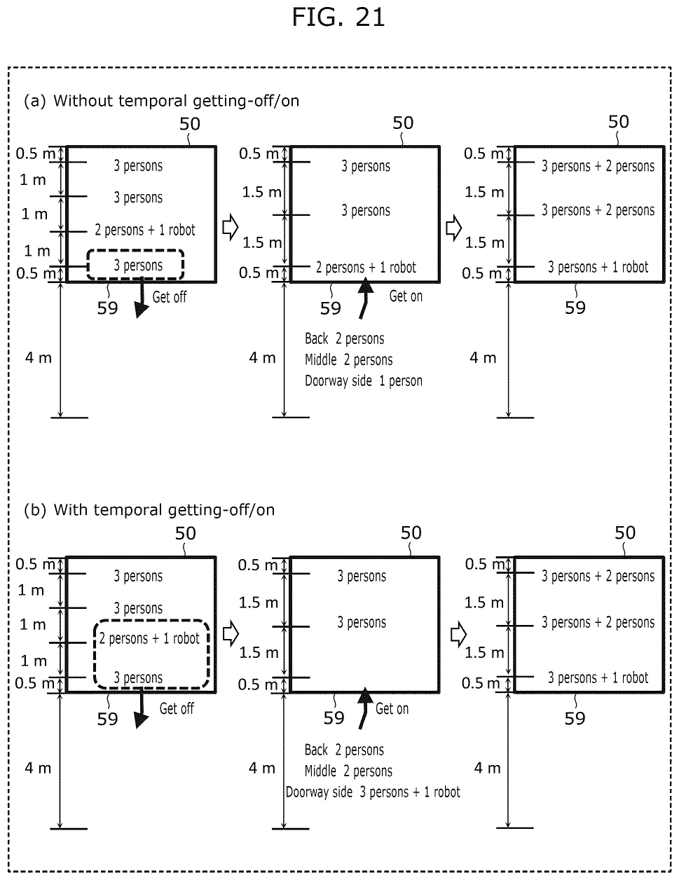

FIG. 21 is a diagram illustrating Calculation example 1 of temporal getting-off/on.

In the example illustrated in FIG. 21, the size of the cage of the elevator is assumed to be 4 m long and 4 m wide. The getting-on/off time will be estimated for the case where one robot 10 gets on the cage, and the elevator arrives at a stopping floor just previous to a floor at which robot 10 is to get off. The numbers of persons who get off the case on the arrival at the stopping floors are as follows: three persons who get off at this floor, two persons who get off together with robot 10 at the next floor, and six persons who get off at the later floors. Of the six persons, three persons get off at a few floors ahead, and three persons get off at a much later floor. The numbers of persons who get on at the stopping floors are as follows: one person gets on at the next floor, and four persons get on at the other floors. Of the four persons, two persons get on at a few floors ahead, and two persons get on at a much later floor.

Note that the distances to the back, middle, and doorway-side positions in the cage are values used for the purpose of calculational convenience, and in an actual cage, all persons and the like are not necessarily arranged in lines at the positions but are scatteredly distributed spaced away from one another.

In FIG. 21, (a) illustrates an example in which nobody gets off and gets on the elevator again, and (b) illustrates an example in which two persons and one robot in the cage of the elevator get off and get on the elevator again.

As illustrated in (a) in FIG. 21, in the case of without temporal getting-off/on, the getting-off takes (4+0.5)/1.5=3 seconds, and the getting-on takes (4+3.5+1+0.5)/1.5=6 seconds, 9 seconds in total. As illustrated in (b) in FIG. 21, in the case of with temporal getting-off/on, the getting-off takes (4+1.5)/1.5=3.7 seconds, and the getting-on takes (4+3.5+0.5)/1.5=5.3 seconds, 9 seconds in total. In this case, there is no difference in time, and thus the temporal getting-off/on is not performed.

More in detail, in the getting-off in the case of (a) without temporal getting-off/on, the three persons move a distance of (4+0.5) m at a speed of 1.5 m/s at the same time, thus taking 3 seconds. In addition, in the getting-on in the case of (a) without temporal getting-off/on, the first person to go to the back moves a distance of (4+3.5) m to reach the back, and the second person needs to move an additional 1 m. When the second person to go to the back reaches the back, the second person to go to the middle is at the position 0.5 m away from the middle. When the second person reaches the middle, the person to go to the doorway side has already arrived. Thus, the time taken by these is calculated as the division of the distance (4+3.5+1+0.5) m by the speed 1.5 m/s, 6 seconds. Therefore, the case of (a) takes 9 seconds in total.

In contrast, in the getting-off in the case of (b) with temporal getting-off/on, the two persons and one robot 10 move a distance of (4+1.5) m at a speed of 1.5 m/s, thus taking 3.7 seconds. The three persons who get off at this stopping floor have already gotten off because their distance to the doorway is short. In addition, in the getting-on in the case of (b) with temporal getting-off/on, the persons to go to the back, the persons to go to the middle, robot 10 to go to the doorway side, and the persons to go to the doorway side can move together because there is no interference with the getting-on. As a result, when the persons to go to the back reach the back, the persons to go to the middle have already reached the middle, and the persons to go to the doorway side are at the point behind robot 10 at which the persons are to move 0.5 m to reach the doorway side. Thus, the time taken by these is calculated as the division of the distance (4+3.5+0.5) m by the speed 1.5 m/s, 5.3 seconds. Therefore, the case of (b) takes 9 seconds in total. In the case illustrated in FIG. 21, the getting-on/off times are both 9 seconds, which make no difference. Thus, the determination is made such that the temporal getting-off/on is not performed.

Next, Calculation example 2 of temporal getting-off/on will be described.

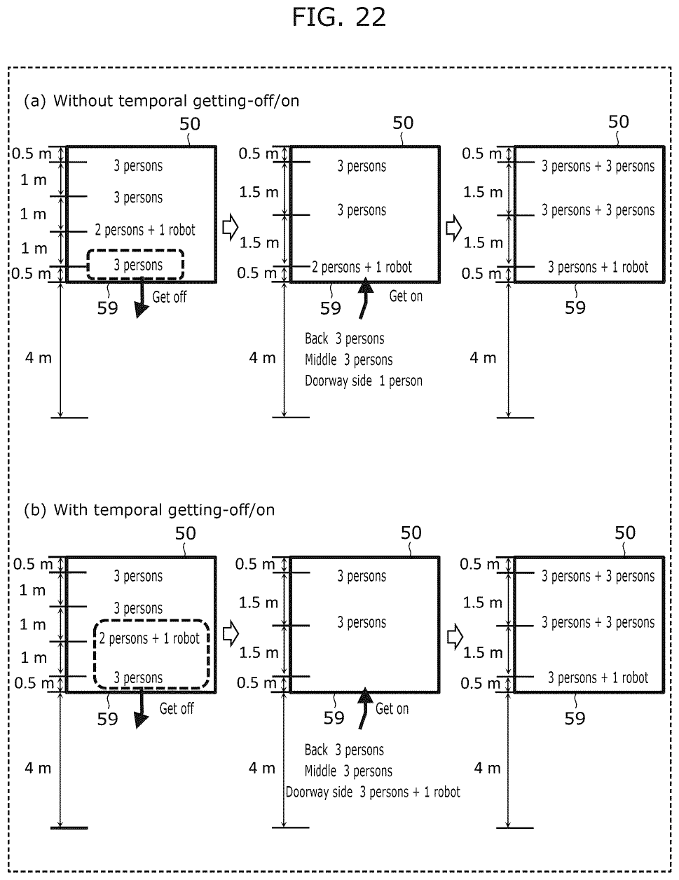

FIG. 22 is a diagram illustrating Calculation example 2 of temporal getting-off/on.

In the example illustrated in FIG. 22, the size of the cage of the elevator is assumed to be 4 m long and 4 m wide. The getting-on/off time will be estimated for the case where one robot 10 gets on the cage, and the elevator arrives at a stopping floor just previous to a floor at which robot 10 is to get off. The numbers of persons who get off the cage on the arrival at the stopping floors are as follows: three persons who get off at this floor, two persons who get off together with robot 10 at the next floor, and six persons who get off at the later floors. Of the six persons, three persons get off at a few floors ahead, and three persons get off at a much later floor. The numbers of persons who get on the cage at the stopping floors are as follows: one person who gets on at the next floor, and six persons who get on at the other floors. Of the six persons, three persons get on at a few floors ahead, and three persons get on at a much later floor.

Note that the distances to the back, middle, and doorway-side positions in the cage are values used for the purpose of calculational convenience, and in an actual cage, all persons and the like are not necessarily arranged in lines at the positions but are scatteredly distributed spaced away from one another.

In FIG. 22, (a) illustrates an example in which nobody gets off and gets on the elevator again, and (b) illustrates an example in which two persons and one robot in the cage of the elevator get off and get on the elevator again.

As illustrated in (a) in FIG. 22, in the case of without temporal getting-off/on, the getting-off takes (4+0.5)/1.5=3 seconds, and the getting-on takes (4+3.5+2+0.5+1)/1.5=7.3 seconds, 10.3 seconds in total. As illustrated in (b) in FIG. 22, in the case of with temporal getting-off/on, the getting-off takes (4+1.5)/1.5=3.7 seconds, and the getting-on takes (4+3.5+0.5)/1.5=5.3 seconds, 9 seconds in total. In this case, the temporal getting-off/on shortens the time. Thus, the temporal getting-off/on is performed.

More in detail, in the getting-off in the case of (a) without temporal getting-off/on, the three persons move a distance of (4+0.5) m at a speed of 1.5 m/s at the same time, thus taking 3 seconds. In addition, in the getting-on in the case of (a) without temporal getting-off/on, the first person to go to the back moves a distance of (4+3.5) m to reach the back, and the third person needs to move an additional 2 m. When the third person to go to the back reaches the back, the third person to go to the middle is at the position 0.5 m away from the middle. When the persons reach the middle, the person to go to the doorway side is at the point 1 m away from the doorway side. Thus, the time taken by these is calculated as the division of the distance (4+3.5+2+0.5+1) m by the speed 1.5 m/s, 7.3 seconds. Therefore, the case of (a) takes 10.3 seconds in total.

In contrast, in the getting-off in the case of (b) with temporal getting-off/on, the two persons and one robot 10 move a distance of (4+1.5) m at a speed of 1.5 m/s, thus taking 3.7 seconds. The three persons who get off at this stopping floor have already gotten off because their distance to the doorway is short. In addition, in the getting-on in the case of (b) with temporal getting-off/on, the persons to go to the back, the persons to go to the middle, robot 10 to go to the doorway side, and the persons to go to the doorway side can move together because there is no interference with the getting-on. As a result, when the persons to go to the back reach the back, the persons to go to the middle have already reached the middle, and the persons to go to the doorway side are at the point behind robot 10 at which the persons are to move 0.5 m to reach the doorway side. Thus, the time taken by these is calculated as the division of the distance (4+3.5+0.5) m by the speed 1.5 m/s, 5.3 seconds. Therefore, the case of (b) takes 9 seconds in total. In the case illustrated in FIG. 22, the getting-on/off time is 10.3 seconds in the case of without temporal getting-off/on, and the getting-on/off time is 9 seconds in the case of with temporal getting-off/on. As a result, the temporal getting-off/on shortens the time. Thus, the determination is made such that temporal getting-off/on is performed.

Note that, in the examples described above, the moving speeds of the persons and robot 10 are set to the same speed: 1.5 m/s. However, this is not limiting. The moving speed of the persons and the moving speed of robot 10 may be different from each other.

The moving speed of a person may be set according to the attribute of the person, such as an able-bodied person, an older person, a person pushing a stroller, or a wheelchair user. The attribute of a person is desirably grasped when the person specifies their getting-off floor before getting on the elevator. The attribute of a person may be grasped based on a video from a camera or based on a registration application from a passenger. To calculate the getting-on/off time, an average speed of target persons is used.

The stopping floors of the elevator and passengers (persons) and robots 10 to be permitted to get on at the stopping floors are determined based on information on the attributes, the waiting times, the getting-on floors, the getting-off floors, and the number of accompanying persons of passengers and robots 10 waiting at the floors and the total number of the passengers and robots 10 and information on the attributes and the getting-off floors of passengers and robots 10 currently being on the elevator and the total number of the passengers and robots 10, which are gathered in mobile body management server 5. The presence or absence and the details of the movement of robot 10 to get on the elevator are determined by estimating getting-on/off times at the stopping floors about the case where robot 10 does not move at all in the cage of the elevator until the getting-off floor, the case where robot 10 moves toward the doorway side after the door closes at a floor just previous to a stopping floor and before the door opens at the stopping floor, and the case where robot 10 gets off and gets on the elevator again at the floor just previous to a stopping floor.

Note that in the case where another robot 10 newly gets on the cage at a stopping floor, temporal getting-off/on of robot 10 is performed at a scheduled disposition place of robot 10 in the cage and on the doorway side in the cage.

That is, in the case where another robot 10 is to newly go to the back in the cage, all robots 10 and persons in the cage once get off. After the other robot 10 goes to the back in the cage, robots 10 and the persons to go to the back, the middle, and the doorway side in the cage get on in order.

In the case where another robot 10 is to newly go to the middle in the cage, robots 10 and persons at the middle and the doorway side in the cage once get off, then persons to go to the back in the cage next get on, then the other robot 10 goes to the middle in the cage, and then robots 10 and persons to go to the middle and the doorway side in the cage get on in order.

In the case where another robot 10 is to newly go to the doorway side in the cage, robots 10 and persons on the doorway side in the cage once get off, then persons to go to the back in the cage and persons to go to the middle in the cage next get on the cage, then the other robot 10 goes to the doorway side in the cage, and then persons to go to the doorway side get on the cage. Note that the persons who get on the cage may include other persons newly getting on at the stopping floor.

### OTHER EMBODIMENTS

Although the embodiments and their variations (hereinafter, referred also to as “embodiments and the like”) have been described, the present disclosure is not limited to the embodiments and the like.

For example, in the case where the determination in step S130 in FIG. 15 is that the getting-on/off time is to be shortened, the preparatory movement performed by robot 10 at a stopping floor just previous to the getting-off floor of robot 10 is robot 10's getting off and getting on the elevator again. In the case where robot 10 gets off and gets on the elevator again, the getting off and on of robot 10 lengthen the time. However, the getting off and getting on the elevator again eliminates the hindrance to the getting-on of a person and another robot 10, allowing them to get on the cage of the elevator at the same time. Thus, the getting-on time is shortened. In the case where robot 10 does not get off and get on the elevator again, although the time is not lengthened by the getting off and on of robot 10, there is a hindrance to the getting-on of a person and another robot 10, forcing them to get on one by one. Thus, the getting-on time is lengthened. In this case, it is desirable to make the determination by comparing the total of the getting-on time and the getting-off time between the presence and absence of temporal getting-off/on.

For example, in the case where the determination in step S190 in FIG. 15 is that the getting-on/off time is to be shortened, the preparatory movement performed by robot 10 after a stopping floor just previous to the getting-off floor by the time the elevator arrives the getting-off floor is robot 10's moving its place in the cage. In this case, robot 10 approaches the doorway side or changes its orientation. If robot 10 can move in the cage, the amount of movement of robot 10 after the elevator arrives the getting-off floor is reduced, which shortens the getting-off time.

For example, in the handing in the second example in Embodiment 2, the “disposition for getting-off preparation” (the disposition in which a person and robot 10 getting-off at a much later floor are located on the back side in the cage and a person and robot 10 getting-off at a just next floor are located on the doorway side) is usually performed. However, if it is already known that temporal getting-off/on is to be performed at the next floor, getting-on is not needed for the getting-off preparation at the floor. Therefore, it is only required to cause the persons and robots 10 currently being in the cage to shift to the back before getting on. The process and determination described above are equivalent to Yes in step S320 in FIG. 16A.

The above is the case where new robot 10 gets on to the back in the cage or the case where many new persons get on to the back in the cage. All the persons and robot 10 allowed to once get on are caused to get on, caused to get off at the next floor, and get on the cage together with persons and robots 10 getting on at this floor, in conformity to the “disposition for getting-off preparation.” This handing can occur in the case where many persons newly get on the cage at two consecutive stopping floors.

In contrast, in the case where the determination in step S320 is No, the getting off and getting on the elevator again is not performed. Thus, if the getting-on is performed without management, the disposition in the cage does not conform to the “disposition for getting-off preparation.” Thus, the getting-on is performed in conformity to the “disposition for getting-off preparation.”

Whether all persons and robot 10 in the cage are to move for temporal getting-off/on at the next floor is determined by mobile body management server 5. For example, the determination is made by calculating getting-on time (A) of the case where the disposition for getting-off preparation is performed at the current stopping floor, getting-on time (B) of the case where only getting-on is performed at the current stopping floor, getting-on/off time (C) of the case where temporal getting-off/on is not performed at the next stopping floor for the disposition for getting-off preparation, and getting-on/off time (D) of the case where temporal getting-off/on is performed after all get off at the next stopping floor, based on information on the attributes and the getting-off floors of persons and robots 10 in the cage at the current stopping floor after getting-on and the total number of the persons and robots 10, and based on information on the attributes and the getting-off floors of persons and robots 10 to get on at the next stopping floor and the total number of the persons and robots 10, and by comparing the time (A+C) and the time (B+D).

When the time (A+C) is shorter, temporal getting-off/on is not performed (No in S320), and when the time (B+D) is shorter, temporal getting-off/on is performed (Yes in S320).

In this case, the information described above is sent from mobile body management server 5 to mobile body conveyance system 5a and from mobile body management server 5 via robot management server 2 to robot 10. The information on the attributes, the waiting times, the getting-on floors, the getting-off floors, the number of accompanying persons, and the like of the persons and robots 10 to get on the elevator, which is needed for the operation of the elevator, may be registered by users before the getting-on and aggregated in mobile body management server 5.

Furthermore, the operations of the elevator system without the disposition for getting-off preparation will be described.

The preliminary action will be described. Notifying the surroundings of the movement before robot 10 moves can be applied to even the case where the disposition for getting-off preparation is not performed in the cage. In the case where the disposition for getting-off preparation is performed, a person present closer to the doorway than robot 10 gets off at a floor earlier than or the same stopping floor as that of robot 10. Thus, there is no person who hinders the getting-off of robot 10. In contrast, in the case where the disposition for getting-off preparation is not performed, a person whose getting-off floor is later than that of robot 10 is present between robot 10 and the doorway may hinder the getting-off of robot 10. In this case, it is desirable to provide the notification of the getting-off of robot 10 in the form of the preliminary action or the preparatory notification so as to cause the person to move so that the person does not interfere with the getting-off.

The preparatory movement in the cage will be described. A person in the vicinity of robot 10 does not expect the movement of robot 10 in the cage before the elevator arrives at a stopping floor. Thus, it is desirable to notify the person in the vicinity of robot 10 that robot 10 is to move as the preliminary action, irrespective of whether the disposition for getting-off preparation is performed.

The preparatory movement for temporal getting-off/on will be described. The preparatory movement regarding whether temporal getting-off/on is needed at each stopping floor cannot be determined without information on persons and robots 10 on the cage and the getting-off floors and the number of persons and robots 10 to get on at the next stopping floor, and the like. Therefore, if a person does not get on the elevator at a place in the cage according to the getting-off floor of the person, temporal getting-off/on needs to be performed every time the elevator arrives a stopping floor.

The waiting time for mobile body 50 will be described. In the case where no consideration is given to the waiting times of persons and robots 10 waiting for getting on at each stopping floor, the persons and robots 10 can get on only at a floor at which many persons and robots 10 get off, and there may be a floor at which none of persons or robots 10 can get on. With consideration given to the waiting times, a limit to the number of getting-on passengers may be needed even when there is an unoccupied space in the cage, so as to allow persons and robots 10 to get on at a later stopping floor.

General or specific aspects of the present disclosure may be implemented to a system, a device, a method, an integrated circuit, a computer program, a non-transitory computer-readable recording medium such as a Compact Disc-Read Only Memory (CD-ROM), or any given combination thereof.

An order of performing the steps in each of the flowcharts of the embodiments and the like is an example. The steps may be performed in different orders. A plurality of steps may be performed in parallel.

The dividing of the functional blocks in each of the block diagrams is one example. It is possible that a plurality of functional blocks are implemented into a single functional block, that a single functional block is divided into a plurality of functional blocks, and that a function executed by a functional block is partially executed by another functional block. Furthermore, similar functions of a plurality of functional blocks may be executed by a single hardware or software in parallel or by time division.

Each of the constituent elements (for example, processing units such as a controller) in each of the above embodiments may be implemented to an exclusive hardware product, or may be realized by executing a software program suitable for the element. Each of the elements may be realized by means of a program executing unit, such as a Central Processing Unit (CPU) or a processor, reading and executing the software program recorded on a recording medium such as a hard disk or semiconductor memory. The constituent elements may be implemented to circuits (or integrated circuits). These circuits may form a single circuit, or serve as separate circuits. Each circuit may be may be a general-purpose circuit or a dedicated circuit.

In addition, the present disclosure may include embodiments obtained by making various modifications on the above embodiments which those skilled in the art will arrive at, or embodiments obtained by selectively combining the constituent elements and functions disclosed in the above embodiments, without materially departing from the scope of the present disclosure.

### INDUSTRIAL APPLICABILITY

The present disclosure can be widely available as mobile robots.

1. A robot that is mobile, the robot comprising:
a controller that controls the robot; and
an action unit that performs an action based on an instruction from the controller, wherein
the controller causes the action unit to perform a preliminary action before the robot starts to move in a place where the robot and a person are present together.

2. The robot according to claim 1, wherein
the action unit is at least one of a loudspeaker, a light, an image outputter, a movable mechanism, or a mobilizing mechanism for moving the robot.

3. The robot according to claim 1, wherein
the controller causes the action unit to perform the preliminary action before the robot gets off a mobile body that moves in order to transport a person.

4. The robot according to claim 3, wherein
the controller outputs, to the action unit, a preliminary action signal for causing the action unit to perform the preliminary action, and
the action unit performs the preliminary action upon receiving the preliminary action signal.

5. The robot according to claim 4, wherein
the action unit includes a mobilizing mechanism for moving the robot, and
the controller drives the mobilizing mechanism to perform the preliminary action, by outputting the preliminary action signal to the action unit.

6. The robot according to claim 5, wherein
the controller drives the mobilizing mechanism to cause the robot to get off the mobile body, by outputting a main action signal to the action unit after outputting the preliminary action signal.

7. The robot according to claim 3, wherein
the controller causes the action unit to perform the preliminary action, based on current position information of the mobile body and information on a location where the robot is to get off the mobile body.

8. The robot according to claim 7, wherein
the information on the location where the robot is to get off the mobile body is information on a scheduled getting-off location where the robot is scheduled to get off the mobile body.

9. The robot according to claim 7, wherein
the information on the location where the robot is to get off the mobile body is information on an emergency stop location where the mobile body stops in an emergency.

10. The robot according to claim 3, wherein
the controller causes the action unit to perform the preliminary action, when a floor occupancy proportion that is a proportion of (i) a floor area occupied by the robot and a person on a floor of the mobile body to (ii) a floor area of the floor of the mobile body is higher than a predetermined threshold.

11. The robot according to claim 3, wherein
the controller causes the action unit to perform the preliminary action to prevent the robot from coming in contact with a person in a vicinity of the robot.

12. The robot according to claim 3, wherein
the controller causes the action unit to perform the preliminary action to enable a person located in a moving direction of the robot to notice the preliminary action.

13. The robot according to claim 3, wherein
the controller causes the action unit to perform the preliminary action according to a type of a person in the mobile body.

14. The robot according to claim 3, wherein
when a person is in the mobile body, the controller causes the action unit to perform the preliminary action, and
when no person is in the mobile body, the controller does not cause the action unit to perform the preliminary action.

15. The robot according to claim 3, further comprising:
a detector that detects an inside of the mobile body, wherein
the controller causes the action unit to perform the preliminary action based on information obtained by the detector.

16. The robot according to claim 3, wherein
the robot is configured to move in the mobile body before the robot gets off the mobile body, and
the controller causes the action unit to perform the preliminary action before the robot moves in the mobile body.

17. The robot according to claim 3, wherein
the robot is configured to get off and get on the mobile body again at a location that is different from a destination before getting off the mobile body at the destination, and
the controller causes the action unit to perform the preliminary action before the robot moves to get off and get on again the mobile body at the location.

18. A robot control method of controlling a robot that is mobile, the robot control method comprising:
causing the robot to perform a preliminary action before the robot starts to move in a place where the robot and a person are present together.

19. The robot control method according to claim 18, wherein
the preliminary action is performed before the robot gets off a mobile body that moves in order to transport a person.
